(19) United States
(12) Patent Application Publication
(10) Pub. No.: US 2016/0243825 A1
(43) Pub. Date: Aug. 25, 2016

(54) LIQUID DISCHARGING APPARATUS AND CONTROL METHOD OF LIQUID DISCHARGING APPARATUS

(71) Applicant: Seiko Epson Corporation, Tokyo (JP)

(72) Inventors: Masashi KAMIYANAGI, Suwa (JP); Toshiyuki SUZUKI, Matsumoto (JP)

(21) Appl. No.: 14/993,362

(22) Filed: Jan. 12, 2016

(30) Foreign Application Priority Data
Feb. 19, 2015 (JP) 2015-030832

(51) Int. Cl. B41J 2/045

(52) U.S. Cl. CPC B41J 2/04563; B41J 2/04581

(57) ABSTRACT

A liquid discharging apparatus includes a housing, a head unit that is provided in the housing, and includes a discharge section, which is provided with a piezoelectric element that is displaced depending on a driving signal, a driving signal creation section that creates the driving signal, a temperature information creation section that creates temperature information, which shows a temperature of a predetermined location inside the housing, a detection signal creation section that creates a detection signal by amplifying a residual vibration signal, which shows residual vibrations that occur in the discharge section after the piezoelectric element is displaced depending on the driving signal, with an amplification factor that depends on a temperature, which the temperature information shows, and a discharge state determination section that determines a discharge state of the liquid in the discharge section on the basis of the detection signal.

This application claims priority to Japanese Patent Application No. 2015-030832 filed on Feb. 19, 2015. The entire disclosure of Japanese Patent Application No. 2015-030832 is hereby incorporated herein by reference.

### BACKGROUND

1. Technical Field

The present invention relates to a liquid discharging apparatus and a control method of a liquid discharging apparatus.

2. Related Art

A liquid discharging apparatus such as an ink jet printer forms images on a recording medium by discharging a liquid such as ink, which a cavity (a pressure chamber) of a discharge section is filled with, as a result of driving the discharge section using a driving signal. In such a liquid discharging apparatus, there are cases in which a discharge abnormality, in which it is no longer possible to discharge a liquid from the discharge section normally, occurs as a result of thickening of the liquid, the incorporation of an air bubble in the cavity and the like. Further, when a discharge abnormality occurs, it is no longer possible to correctly form intended dots, which are formed on a medium by a liquid that is discharged from the discharge section, and therefore, the image quality of images that the liquid discharging apparatus forms, is reduced.

In JP-A-2004-276544, a technique that prevents a reduction in image quality due to a discharge abnormality by determining a discharge state of a liquid in a discharge section on the basis of residual vibrations that occur in the discharge section after driving the discharge section, is suggested.

Incidentally, the amplitude of the residual vibrations that occur in the discharge section change depending on the viscosity of the liquid that the inside of the discharge section is filled with. Further, the viscosity of the liquid changes depending on the temperature of the liquid. Therefore, there are cases in which fluctuations in the temperature of the liquid cause fluctuations in the amplitude of the residual vibrations that occur in the discharge section, and have an effect on the determination result of the discharge state on the basis of the residual vibrations. As a result of this, there are cases in which it is not possible to correctly determine the discharge state.

### SUMMARY

An advantage of some aspects of the invention is to provide a technique that is capable of improving the precision of the determination of a discharge state of a liquid from a discharge section.

According to an aspect of the invention, there is provided a liquid discharging apparatus including a housing, a head unit that is provided in the housing, and includes a discharge section, which is provided with a piezoelectric element that is displaced depending on a driving signal, a pressure chamber, the internal pressure of which is increased and decreased by displacement of the piezoelectric element, and a nozzle, which is in communication with the pressure chamber, and is capable of discharging a liquid, which the inside of the pressure chamber is filled with, depending on increases and decreases in the internal pressure of the pressure chamber, a driving signal creation section that creates the driving signal, a temperature information creation section that creates temperature information, which shows a temperature of a predetermined location inside the housing, a detection signal creation section that creates a detection signal by amplifying a residual vibration signal, which shows residual vibrations that occur in the discharge section after the piezoelectric element is displaced depending on the driving signal, with an amplification factor that depends on a temperature, which the temperature information shows, and a discharge state determination section that determines a discharge state of the liquid in the discharge section on the basis of the detection signal.

In this case, the residual vibration signal is amplified with an amplification factor that is established depending on the temperature of a predetermined location inside the housing. Inside the housing of the liquid discharging apparatus, there are locations that change in temperature depending on changes in temperature of the liquid, which the discharge section is filled with, as a result the temperature of the corresponding liquid propagating thereto. Even in a case in which the temperature of the liquid fluctuates as a result amplifying the residual vibration signal depending on the temperature of a predetermined location of the liquid discharging apparatus in this manner, it is possible to restrict fluctuations in the amplitude of the detection signal to a small amount. As a result of this, it is possible to perform the determination of the discharge state in the discharge section on the basis of the detection signal with high precision.

Additionally, the temperature of a predetermined location inside the housing may, for example, be a temperature inside the pressure chamber, may be a temperature of the head unit, may be a temperature of a substrate, which is provided separately from the head unit, or may be an atmospheric temperature of the liquid discharging apparatus.

In addition, in the liquid discharging apparatus, the amplification factor, which the detection signal creation section uses in the amplification of the residual vibration signal, in a case in which the temperature, which the temperature information shows, is a first temperature, which is included in a predetermined temperature range, may be higher than the amplification factor, which the detection signal creation section uses in the amplification of the residual vibration signal, in a case in which the temperature, which the temperature information shows, is a second temperature, which is included in the predetermined temperature range, and is higher than the first temperature.

In this case, the amplification factor, which is used in the amplification of the residual vibration signal, is set to be higher in a case in which the predetermined location inside the housing is the first temperature, the temperature of the liquid is low and the viscosity thereof is high, than that in a case in which the predetermined location is the second temperature, the temperature of the liquid is high and the viscosity thereof is low. Therefore, it is possible to configure such that the amplitude of the detection signal in a case in which the viscosity of the liquid is high, and the amplitude of the residual vibration signal is small, and the amplitude of the detection signal in a case in which the viscosity of the liquid is low, and the amplitude of the residual vibration signal is large, are substantially the same. As a result of this, it is possible to perform the determination of the discharge state in the discharge section on the basis of the detection signal with high precision.

According to another aspect of the invention, there is provided a liquid discharging apparatus including a housing, a head unit that is provided in the housing, and includes a discharge section, which is provided with a piezoelectric element that is displaced depending on a driving signal, a pressure chamber, the internal pressure of which is increased and decreased by displacement of the piezoelectric element, and a nozzle, which is in communication with the pressure chamber, and is capable of discharging a liquid, which the inside of the pressure chamber is filled with, depending on increases and decreases in the internal pressure of the pressure chamber, a driving signal creation section that creates the driving signal, a temperature information creation section that creates temperature information, which shows a temperature of a predetermined location inside the housing, a detection signal creation section that creates a detection signal by amplifying a residual vibration signal, which shows residual vibrations that occur in the discharge section after the piezoelectric element is displaced depending on the driving signal, and a discharge state determination section that determines a discharge state of the liquid in the discharge section on the basis of the detection signal and a threshold value signal, which shows a value that depends on the temperature that the temperature information shows, in which the discharge state determination section determines that the discharge state of the liquid in the discharge section is abnormal in a case in which the amplitude of the detection signal is less than a value, which the threshold value signal shows.

In this case, the discharge state of the liquid in the discharge section is determined on the basis of a threshold value signal, which shows a value that depends on the temperature of a predetermined location of the liquid discharging apparatus. Therefore, even in a case in which the amplitude of the residual vibration signal fluctuates as a result of the temperature of the liquid fluctuating, by taking the fluctuations in the amplitude of the residual vibration signal into consideration, it is possible to split the amplitude of the residual vibration signal in a case in which the discharge state is normal, and the amplitude of the residual vibration signal in a case in which the discharge state is abnormal. As a result of this, it is possible to perform the determination of the discharge state in the discharge section with high precision.

In addition, in the liquid discharging apparatus, the value, which the threshold value signal shows in a case in which the temperature, which the temperature information shows, is a first temperature, which is included in a predetermined temperature range, may be smaller than the value, which the threshold value signal shows in a case in which the temperature, which the temperature information shows, is a second temperature, which is included in the predetermined temperature range, and is higher than the first temperature.

In this case, the value, which the threshold value shows, is set to be smaller in a case in which the predetermined location inside the housing is the first temperature, the temperature of the liquid is low and the viscosity thereof is high, than that in a case in which the predetermined location is the second temperature, the temperature of the liquid is high and the viscosity thereof is low. Therefore, even in a case in which the amplitude of the residual vibration signal fluctuates as a result of the temperature of the liquid fluctuating, by taking the fluctuations in the amplitude of the residual vibration signal into consideration, it is possible to split the amplitude of the residual vibration signal in a case in which the discharge state is normal, and the amplitude of the residual vibration signal in a case in which the discharge state is abnormal. As a result of this, it is possible to perform the determination of the discharge state in the discharge section with high precision.

In addition, in the liquid discharging apparatus, the viscosity of the liquid at 20° C. may be 15 mPa·s or more, and 25 mPa·s or less.

If the viscosity of the liquid at 20° C. is 25 mPa·s or less in the manner of the aspect, the discharge stability of the liquid is excellent. In addition, if the viscosity of the liquid at 20° C. is 15 mPa·s or more, the generation of hardening wrinkles is effectively suppressed.

In addition, in the liquid discharging apparatus, the viscosity of the liquid at 30° C. or more and 40° C. or less may be 8 mPa·s or more, and 15 mPa·s or less.

In contrast to having a viscosity at 20° C. of 15 to 25 mPa·s, the liquid in this case has a viscosity at 30 to 40° C. of 8 to 15 mPa·s. That is, the viscosity of the liquid changes greatly in accordance with temperature changes thereof. That is, in this case, when discharging a liquid in which the viscosity changes greatly in accordance with temperature changes in the discharge section, the discharge state of the liquid in the corresponding discharge section is determined taking the changes in viscosity of the liquid, which is discharged into consideration. Therefore, it is possible to perform the determination of the discharge state in the discharge section with high precision.

In addition, according to still another aspect of the invention, there is provided a control method of a liquid discharging apparatus that includes a housing, a head unit that is provided in the housing, and includes a discharge section, which is provided with a piezoelectric element that is displaced depending on a driving signal, a pressure chamber, the internal pressure of which is increased and decreased by displacement of the piezoelectric element, and a nozzle, which is in communication with the pressure chamber, and is capable of discharging a liquid, which the inside of the pressure chamber is filled with, depending on increases and decreases in the internal pressure of the pressure chamber, a driving signal creation section that creates the driving signal, and a temperature information creation section that creates temperature information, which shows a temperature of a predetermined location inside the housing, the method including creating a detection signal by amplifying a residual vibration signal, which shows residual vibrations that occur in the discharge section after the piezoelectric element is displaced depending on the driving signal, with an amplification factor that depends on a temperature, which the temperature information shows, and determining a discharge state of the liquid in the discharge section on the basis of the detection signal.

In this case, the residual vibration signal is amplified with an amplification factor that depends on the temperature of a predetermined location inside the housing. Even in a case in which the temperature of the liquid fluctuates, it is possible to restrict fluctuations in the amplitude of the detection signal to a small amount. As a result of this, it is possible to perform the determination of the discharge state in the discharge section on the basis of the detection signal with high precision.

### BRIEF DESCRIPTION OF THE DRAWINGS

The invention will be described with reference to the accompanying drawings, wherein like numbers reference like elements.

FIG. 1 is a block diagram that shows a configuration of a printing system according to an embodiment of the invention.

FIG. 2 is a schematic partial cross-sectional view of an ink jet printer.

FIG. 3 is a schematic cross-sectional view of a recording head.

FIG. 4 is a plan view that shows an arrangement example of nozzles in the recording head.

FIGS. 5A to 5C are explanatory diagrams that shows changes in the cross-sectional shape of a discharge section during supply of a driving signal.

FIG. 6 is a circuit diagram that shows a simple harmonic motion model, which represents residual vibrations in the discharge section.

FIG. 7 is a graph that shows a relationship between experimental values and calculated values of residual vibrations in the discharge section.

FIG. 8 is an explanatory diagram that shows a state of the discharge section in a case in which an air bubble is incorporated inside the discharge section.

FIG. 9 is a graph that shows experimental values and calculated values of residual vibrations in the discharge section.

FIG. 10 is an explanatory diagram that shows a state of the discharge section in a case in which ink in the vicinity of a nozzle has become fixed.

FIG. 11 is a graph that shows experimental values and calculated values of residual vibrations in the discharge section.

FIG. 12 is an explanatory drawing that shows a state of the discharge section in a case in which paper dust has become adhered.

FIG. 13 is a graph that shows experimental values and calculated values of residual vibrations in the discharge section.

FIG. 14 is a block diagram that shows a configuration of a driving signal creation section.

FIGS. 15A and 15B are explanatory drawings that show decoding contents of a decoder.

FIG. 16 is a timing chart that shows actions of the driving signal creation section.

FIG. 17 is a timing chart that shows actions of the driving signal creation section.

FIG. 18 is a timing chart that shows a waveform of the driving signal.

FIG. 19 is an explanatory diagram for describing a connection relationship between a connection section and a detection signal creation section.

FIG. 20 is a circuit diagram that shows a configuration of the detection signal creation section.

FIG. 21 is a timing chart that shows a waveform of the driving signal.

FIG. 22 is an explanatory diagram for describing determination information.

FIG. 23 is a timing chart that shows a waveform of the driving signal according to a comparative example.

FIG. 24 is a diagram that shows a relationship between a temperature and an amplification factor.

FIG. 25 is a diagram that shows a relationship between a temperature, and threshold values according to Modification Example 1.

FIG. 26 is a timing chart that shows a waveform of the driving signal according to Modification Example 1.

### DESCRIPTION OF EXEMPLARY EMBODIMENTS

Hereinafter, aspects for implementing the invention will be described with reference to the drawings. However, in each figure, the dimensions and scales of each part have been altered from practical dimensions and scales as appropriate. In addition, since the embodiment that is mentioned below is a preferred specific example of the invention, various technically preferable limitations have been applied thereto, but the scope of the invention is not limited to these embodiments unless a feature that specifically limits the invention is disclosed in the following description.

### A. EMBODIMENT

In the present embodiment, a liquid discharging apparatus will be described by illustrating an ink jet printer that forms an image on recording sheets P (an example of a “medium”) by discharging ink (an example of a “liquid”), by way of example.

### 1. Outline of Printing System

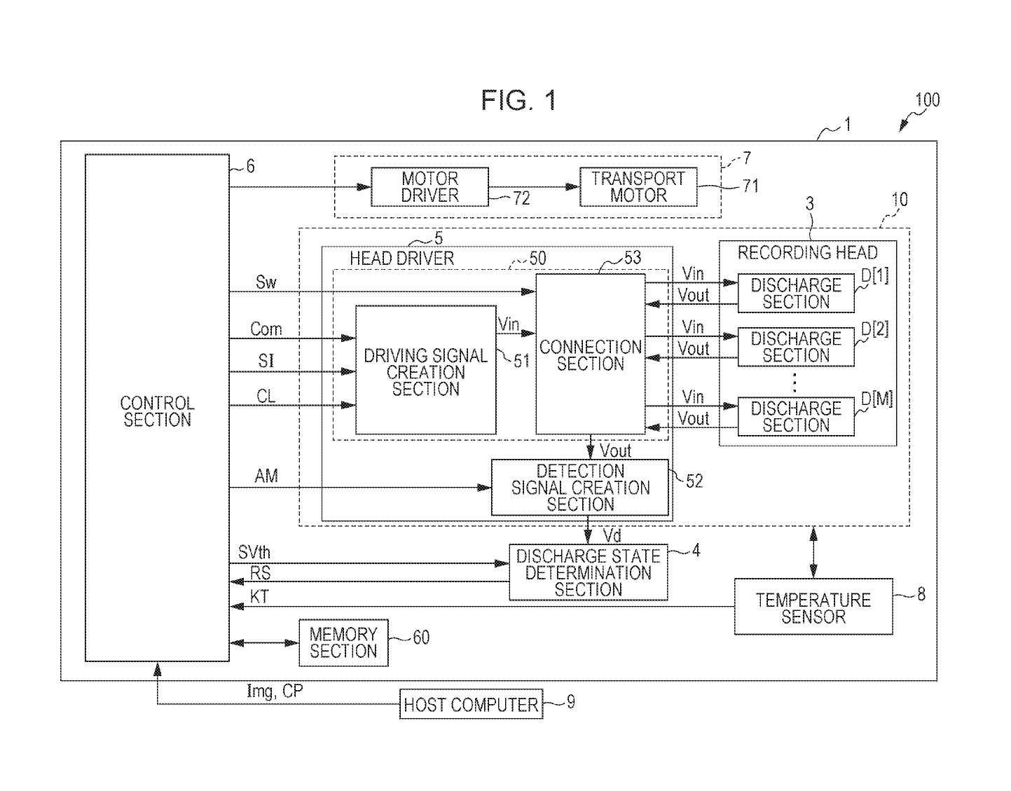

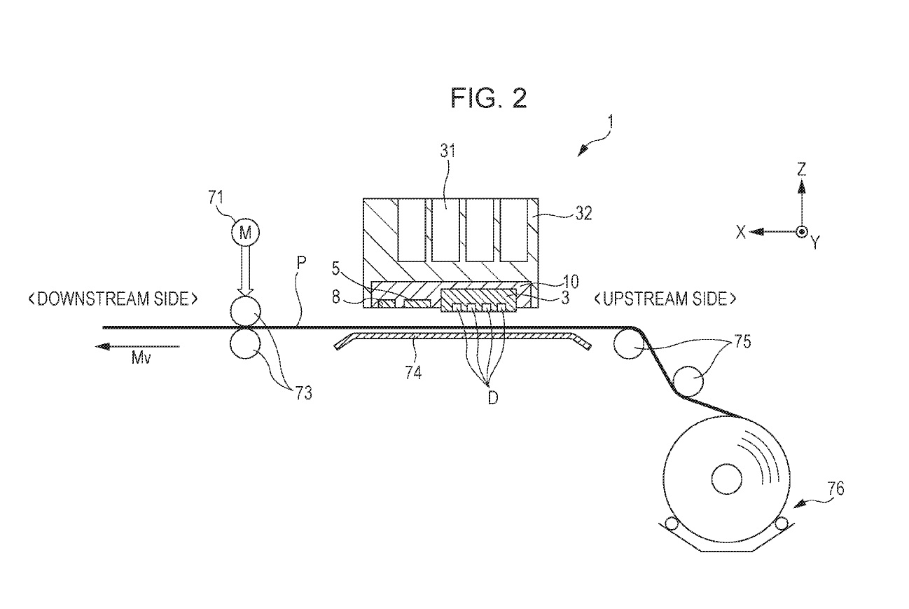

The configuration of an ink jet printer 1 according to the present embodiment will be described with reference to FIGS. 1 and 2.

FIG. 1 is a functional block diagram that shows a configuration of a printing, which is installed in the ink jet printer 1. The printing system 100 is provided with a host computer 9 such as a personal computer or a digital camera, and the ink jet printer 1.

The host computer 9 outputs printing data Img, which shows an image that the ink jet printer 1 should form, and copy number information CP, which shows a printing copy number Wcp of an image that the ink jet printer 1 should form.

The ink jet printer 1 executes a printing process that forms an image, which is shown by the printing data Img that is supplied from the host computer 9, a printing copy number Wcp, which is shown by the copy number information CP, of times on recording sheets P. Additionally, in the present embodiment, description will be given illustrating a case in which the ink jet printer 1 is a line printer, by way of example.

As shown in FIG. 1, the ink jet printer 1 is provided with a housing (not illustrated in the drawing) for accommodating each constituent element of the ink jet printer 1, a head unit 10, in which discharge sections D that discharges ink, is provided, a discharge state determination section 4 that determines discharge states of the ink in the discharge sections D, a transport mechanism 7 for changing a relative position of the recording sheets P with respect to the head unit 10, a temperature sensor 8 that detects the temperature of the ink jet printer 1, a control section 6 that controls the actions of each section of the ink jet printer 1, a memory section 60 that stores a control program of the ink jet printer 1 and other information, a restoration mechanism (not illustrated in the drawing) that executes a maintenance process, which restores the discharge state of the ink in a corresponding discharge section D to normal, a display section that is configured by a liquid crystal display, an LED lamp or the like, and displays error messages, and the like, and a display operation section (not illustrated in the drawing), in which an operation section for a user of the ink jet printer 1 to input various commands, and the like into the ink jet printer 1, is installed.

Additionally, in the present embodiment, in the ink jet printer 1, an aspect in which the head unit 10, the discharge state determination section 4, the control section 6, the transport mechanism 7, the temperature sensor 8, the memory section 60, the restoration mechanism, and the display operation section are accommodated in the housing, is assumed. However, in the ink jet printer 1, it is sufficient if at least the head unit 10 is accommodated in the housing, and the temperature sensor 8 is provided in a position in which it is possible to detect the temperature inside the housing.

FIG. 2 is a partial cross-sectional view that illustrates a schematic of a configuration of the ink jet printer 1.

As shown in FIG. 2, the ink jet printer 1 is provided with a mounting mechanism 32 in which the head unit 10 is mounted. In addition to the head unit 10, four ink cartridges 31 are mounted in the mounting mechanism 32. The four ink cartridges 31 are provided to correspond to the four colors (CMYK) of black (BK), cyan (CY), magenta (MG), and yellow (YL) on a one-to-one basis, and each ink cartridge 31 is filled with an ink of a color that corresponds to the corresponding ink cartridge 31. Additionally, a configuration in which each ink cartridge 31 is provided in a separate site of the ink jet printer 1 instead of being mounted in the mounting mechanism 32 is also possible.

As shown in FIG. 1, the transport mechanism 7 is provided with a transport motor 71, which functions as a driving source for transporting the recording sheets P, and a motor driver 72 for driving the transport motor 71.

In addition, as shown in FIG. 2, the transport mechanism 7 is provided with a platen 74 that is provided on a lower side (a −Z direction in FIG. 2) of the mounting mechanism 32, transport rollers 73 that rotates as a result of the action of the transport motor 71, guide rollers 75 that is provided so as to be capable of freely rotating around a Y axis in FIG. 2, and an accommodation section 76 for accommodating the recording sheets P in a state of being rolled up in roll form.

In a case in which the ink jet printer 1 is executing a printing process, the transport mechanism 7 sends out the recording sheets P from the accommodation section 76, and transports the recording sheets P in a +X direction (a direction that runs toward a downstream side from the upstream side) in the drawing along a transport pathway that is defined by the guide rollers 75, the platen 74 and the transport rollers 73 at a transport speed Mv.

The memory section 60 is provided with EEPROM (Electrically Erasable Programmable Read-Only Memory), which is a type of non-volatile semiconductor memory that stores the printing data Img, which is supplied from the host computer 9, RAM (Random Access Memory), which temporarily stores data that is necessary when executing various processes such as the printing process, or temporarily develops a control program for executing various process such as the printing process, and PROM, which is a type of non-volatile semiconductor memory that stores a control program for controlling each section of the ink jet printer 1.

The control section 6 is configured to include a CPU (Central Processing Unit), an FPGA (field-programmable gate array) and the like, and the CPU controls the actions of each section of the ink jet printer 1 by acting in accordance with a control program that is stored in the memory section 60.

Further, the control section 6 controls the execution of a printing process, which forms an image that depends on the printing data Img on the recording sheets P, by controlling the head unit 10 and the transport mechanism on the basis of the printing data Img that is supplied from the host computer 9, and the like.

More specifically, firstly, the control section 6 stores the printing data Img, which is supplied from the host computer 9, in the memory section 60.

Next, the control section 6 creates signals such as a printing signal SI, and a driving waveform signal Com for driving the discharge sections D by controlling the actions of the head unit 10 on the basis of various data such as the printing data Img that is stored in the memory section 60. In addition, the control section 6 creates a clock signal CL for controlling the actions of the head unit 10.

In addition, the control section 6 creates a signal for controlling the actions of the motor driver 72 on the basis of the printing signal SI and various data that is stored in the memory section 60, and outputs the various created signals. Additionally, although described in more detail later, the driving waveform signal Com according to the present embodiment includes driving waveform signals Com-A and Com-B.

Additionally, the driving waveform signal Com is an analog signal. Therefore, the control section 6 includes a DA conversion circuit, which is not illustrated in the drawings, and outputs a digital driving waveform signal, which is created in the CPU, or the like, that the control section 6 is provided with, after conversion into an analog driving waveform signal Com.

In this manner, the control section 6 drives the transport motor 71 in a manner in which the recording sheets P is transported in the +X direction using the control of the motor driver 72, and, in addition, controls the presence or absence of discharge from the discharge sections D, an ink discharge amount, the discharge timing of ink, and the like, using the control of the head unit 10. As a result of this, the control section 6 adjusts a dot size and dot disposition that is formed by ink that is discharged onto the recording sheets P, and controls the execution of the printing process that forms an image, which corresponds to the printing data Img on the recording sheets P.

In addition, although described in more detail later, the control section 6 controls the execution of a discharge state determination process, which determines whether or not the discharge state of the ink from each discharge section D is normal, that is, whether or not there is a discharge abnormality in each discharge section D.

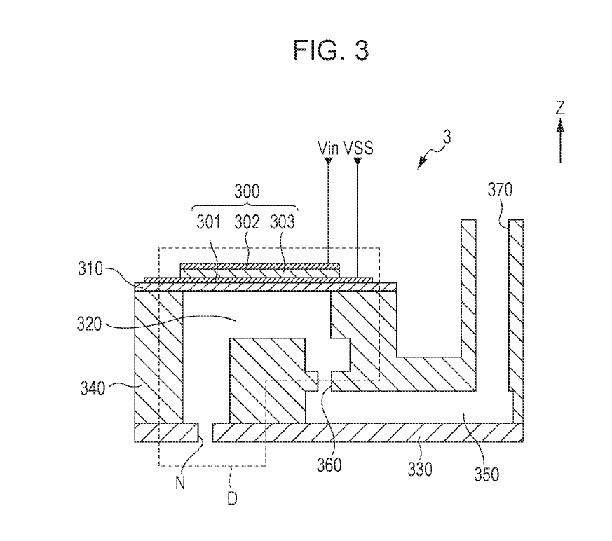

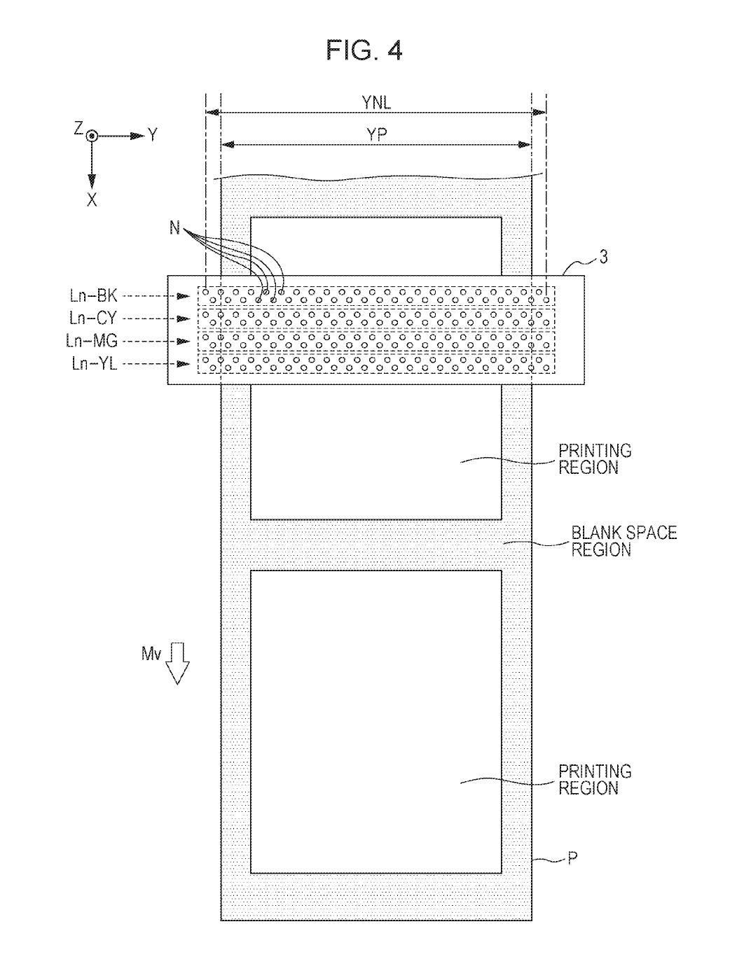

In this instance, a discharge abnormality refers to a state in which the discharge state of the ink in the discharge sections D is abnormal, or in other words, a state in which it is not possible to correctly discharge the ink from the nozzles N (refer to FIGS. 3 and 4, which will be described later), which the discharge sections D are equipped with. More specifically, discharge abnormalities include a state in which the discharge sections D cannot discharge the ink, a state in which the discharge sections D cannot discharge an amount of the ink that is required in order to form an image, which is shown by the printing data Img, as a result of an ink discharge amount being small even in a case in which it is possible to discharge the ink from the discharge sections D, a state in which an amount of the ink that is required in order to form an image, which is shown by the printing data Img, or more is discharged from the discharge sections D, a state in which the ink, which is discharged from the discharge sections D, lands in a position that differs from a predetermined landing position in order to form an image, which is shown by the printing data Img, and the like.

As shown in FIG. 1, the head unit 10 is provided with a recording head 3, in which M discharge sections D are equipped, and the head driver 5 that drives each discharge section D, which the recording head 3 is equipped with (In the present embodiment, M is a nonnegative integer of 4 or more). Additionally, hereinafter, the respective M discharge sections D will be referred to as a first stage, a second stage, . . . , and an M^{th} stage in order to discriminate therebetween. In addition, hereinafter, there are cases in which an m^{th} stage discharge section D is represented by discharge sections D[m] (a variable m is a nonnegative integer that satisfies 1≦m≦M).

The respective M discharge sections D receives the supply of ink from either one of the four ink cartridges 31. The inside of each discharge section D is filled with the ink, which is supplied from the ink cartridges 31, and each discharge section D can discharge the ink, with which it is filled, from the nozzle N, which the corresponding discharge section D is equipped with. More specifically, each discharge section D forms dots for configuring an image on the recording sheets P by discharging the ink onto the recording sheets P at a timing with which the transport mechanism 7 transports the recording sheets P onto the platen 74. Further, full color printing is realized by discharging ink of the four colors of CMYK overall from the M discharge sections D.

As shown in FIG. 1, the head driver 5 is provided with a driving signal supply section 50 that supplies the driving signal Vin for respectively driving the M discharge sections D, which the recording head 3 is provided with, to each discharge section D, and a detection signal creation section 52 that detects residual vibrations that occur in the discharge sections D after the discharge sections D are driven by the driving signal Vin, and outputs a detection result as a detection signal Vd.

The driving signal supply section 50 is provided with a driving signal creation section 51 and a connection section 53.

The driving signal creation section 51 creates the driving signal Vin for respectively driving the M discharge sections D, which the recording head 3 is provided with, on the basis of the signals such as the printing signal SI, the clock signal CL, and the driving waveform signal Com, which are supplied from the control section 6.

The connection section 53 is electrically connected to either one of the driving signal creation section 51 and the detection signal creation section 52 on the basis of a connection control signal Sw that is supplied from the control section 6. The driving signal Vin, which is created in the driving signal creation section 51, is supplied to the discharge sections D via the connection section 53. When the driving signal Vin is supplied, each discharge section D is driven on the basis of the supplied driving signal Vin, and it is possible to discharge the ink, which the inside of the discharge sections D is filled with, onto the recording sheets P.

The detection signal creation section 52 detects a residual vibration signal Vout, which shows residual vibrations that occur in the discharge sections D after the corresponding discharge sections D are driven by the driving signal Vin. Further, the detection signal creation section removes a noise component from the detected residual vibration signal Vout, creates the detection signal Vd by carrying out a process such as amplifying the signal level, and outputs the created detection signal Vd as a detection result of residual vibrations in the discharge sections D. Additionally, in the present embodiment, the driving signal supply section 50 and the detection signal creation section 52 are, for example, mounted as an electronic circuit on a substrate that is provided in the head unit 10.

The discharge state determination section 4 determines a discharge state of the ink in the discharge sections D on the basis of the detection signal Vd that the detection signal creation section 52 outputs, and creates determination information RS, which shows the corresponding detection result. Additionally, in the present embodiment, the discharge state determination section 4 is, for example, mounted as an electronic circuit on a substrate that is provided at a site that differs from that of the head unit 10.

As shown in FIG. 1, the temperature sensor 8 detects the temperature of the head unit 10, creates temperature information KT, which shows the detection result, and outputs this.

Additionally, in the present embodiment, a case in which the temperature sensor 8 detects the temperature of the head unit 10 as a result being mounted in an electronic circuit on a substrate that is provided in the head unit 10, is assumed, but the invention is not limited to such an aspect, and the temperature sensor 8 may detect the temperature of the ink jet printer 1. However, in a case in which the ink, with which the discharge sections D are filled, changes in temperature, it is preferable that the location which is set as the target of the temperature detection of the temperature sensor 8 is a location at which the temperature changes depending on the corresponding changes in temperature of the ink. Therefore, it is preferable that the temperature sensor 8 is provided so as to be capable of detecting the temperature of a predetermined location inside the housing of the ink jet printer 1. That is, the temperature sensor 8 is an example of a temperature information creation section that creates the temperature information KT, which shows the temperature of a predetermined location inside the housing of the ink jet printer 1.

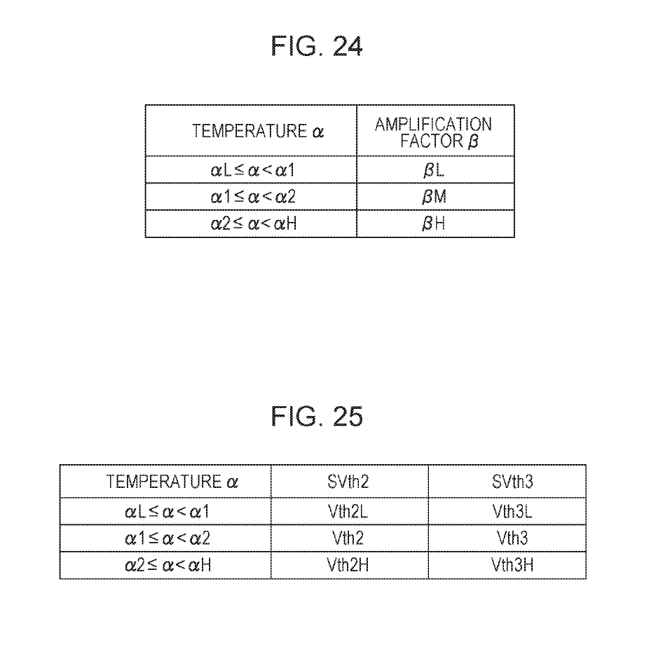

The control section 6 creates an amplification factor indication signal AM, which indicates the amplification factor β when the detection signal creation section 52 amplifies the residual vibration signal Vout on the basis of the temperature α, which is shown by the temperature information KT that the temperature sensor 8 outputs, and supplies the corresponding amplification factor indication signal AM to the detection signal creation section 52. Although described in more detail later, the amplification factor β is established depending on the temperature α (refer to FIG. 24). In addition, the control section 6 supplies a threshold value signal SVth to the discharge state determination section 4, but this will be described in more detail later.

### 2. Configuration of Recording Head

The recording head 3 and the discharge sections D that are provided in the recording head 3 will be described with reference to FIGS. 3 and 4.

FIG. 3 is an example of a schematic partial cross-sectional view of the recording head 3. Additionally, a single discharge section D of the M discharge sections D that the recording head 3 includes, a reservoir 350 that is in communication with the corresponding single discharge section D through an ink supply opening 360, and an ink intake opening 370 for supplying the ink to the reservoir 350 from the ink cartridges 31, are shown in the figure, for the convenience of illustration.

As shown in FIG. 3, the discharge section D is provided with a piezoelectric element 300, a cavity 320 (an example of a “pressure chamber”), the inside of which is filled with the ink, a nozzle N that is in communication with the cavity 320, and a vibration plate 310. The discharge section D discharges the ink that is inside the cavity 320 from the nozzle N as a result of the piezoelectric element 300 being driven by the driving signal Vin. The cavity 320 of the discharge section D is a space that is partitioned by a cavity plate 340 that is formed in a predetermined shape so as to have a concave section, a nozzle plate 330 in which the nozzle N is formed, and the vibration plate 310. The cavity 320 is in communication with the reservoir 350 through the ink supply opening 360. The reservoir 350 is in communication with a single ink cartridge 31 through the ink intake opening 370.

In the present embodiment, a unimorph (monomorph) type piezoelectric element of the manner shown in FIG. 3, is adopted as the piezoelectric element 300. Additionally, the piezoelectric element 300 is not limited to a unimorph type, and may use a bimorph type, a lamination type or the like.

The piezoelectric element 300 includes a lower section electrode 301, an upper section electrode 302, and a piezoelectric body 303 that is provided between the lower section electrode 301 and the upper section electrode 302. Further, the potential of the lower section electrode 301 is set to a predetermined reference voltage VSS, and when a voltage is applied between the lower section electrode 301 and the upper section electrode 302 as a result of the driving signal Vin being supplied to the upper section electrode 302, the piezoelectric element 300 is deflected (displaced) in a vertical direction in the drawing depending on the corresponding voltage that is applied, and the piezoelectric element 300 vibrates as a result.

The vibration plate 310 is installed in an upper surface aperture section of the cavity plate 340, and the lower section electrode 301 is joined to the vibration plate 310. Therefore, when the piezoelectric element 300 vibrates due to the driving signal Vin, the vibration plate 310 also vibrates. Further, a capacity of the cavity 320 (the pressure inside the cavity 320) changes due to the vibrations of the vibration plate 310, and ink, with which the inside of the cavity 320 is filled, is discharged through the nozzle N. In a case in which the ink inside the cavity 320 is reduced due to discharge of the ink, the ink is supplied from the reservoir 350. In addition, the ink is supplied from the ink cartridges 31 to the reservoir 350 through the ink intake opening 370.

FIG. 4 is an explanatory drawing for describing an example of the disposition of M nozzles N that are provided in the recording head 3 in a case in which the ink jet printer 1 is viewed in plan view from a +Z direction or the −Z direction.

As shown in FIG. 4, nozzle rows Ln, which are formed from a plurality of nozzles N, are aligned in the recording head 3 in four rows. More specifically, four nozzle rows Ln, which are formed from a nozzle row Ln-BK, a nozzle row Ln-CY, a nozzle row Ln-MG, and a nozzle row Ln-YL is provided in the recording head 3. Additionally, the respective pluralities of nozzles N that belong to the nozzle row Ln-BK are nozzles that are provided in a discharge section D that discharges black (BK) ink, the respective pluralities of nozzles N that belong to the nozzle row Ln-CY are nozzles that are provided in a discharge section D that discharges cyan (CY) ink, the respective pluralities of nozzles N that belong to the nozzle row Ln-MG are nozzles that are provided in a discharge section D that discharges magenta (MG) ink, and the respective pluralities of nozzles N that belong to the nozzle row Ln-YL are nozzles that are provided in a discharge section D that discharges yellow (YL) ink. Additionally, the respective four rows of nozzle rows Ln are provided so as to extend in a +Y direction or −Y direction (hereinafter, the +Y direction and the −Y direction will be referred to as the “Y axis direction”) when viewed in plan view. Further, in a case of printing on the recording sheets P (to be precise, among the recording sheets P, a recording sheet P in which the width in the Y axis direction is a maximum width on which printing with the ink jet printer 1 is possible), a range YNL over which each nozzle row Ln extends in the Y axis direction is a range YP in the Y axis direction that the corresponding recording sheets P includes, or more.

As shown in FIG. 4, the plurality of nozzles N that configure each nozzle row Ln are disposed in a so-called zig-zag shape so that the positions in the X axis direction of even-numbered nozzles N from the left side (a −Y side) in the drawing and odd-numbered nozzles N differ from one another. In each nozzle row Ln, an interval (pitch) in the Y axis direction between the nozzles N can be set as appropriate depending on a printing resolution (dpi: dots per inch).

Additionally, as an example, in the manner shown in FIG. 4, the printing process in the present embodiment divides the recording sheets P into a plurality of printing regions (for example, corresponding A4 sized rectangular regions in a case of printing an A4 sized image on the recording sheets P, or a label on label sheets), and a plurality of blank space regions for respectively partitioning the plurality of printing regions, and assumes a case of forming a plurality of images that correspond to the plurality of printing regions on a one-to-one basis.

### 3. Action of Discharge Sections and Residual Vibrations

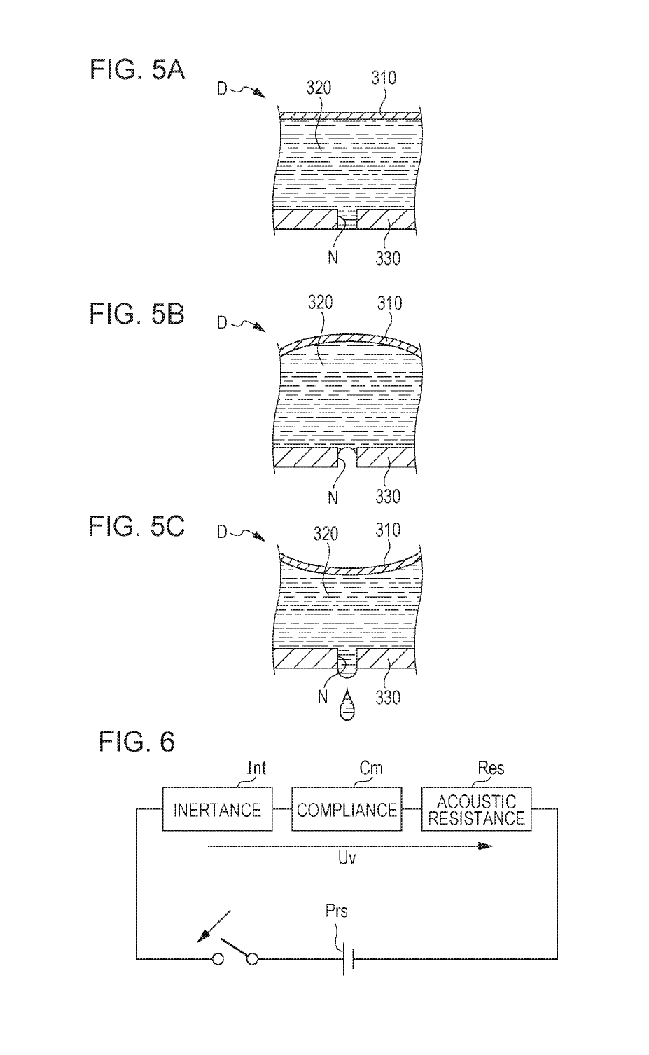

Next, an ink discharge action from the discharge sections D, and the residual vibrations that occur in the discharge sections D will be described with reference to FIGS. 5A to 13.

FIGS. 5A to 5C are explanatory diagrams for describing an ink discharge action from a discharge section D. In a state that is shown in FIG. 5A, when the driving signal Vin is supplied from the head driver 5 to a piezoelectric element 300, which the discharge section D is provided with, in the corresponding piezoelectric element 300, distortion is generated depending on an electric field, which is applied between the electrodes, and the vibration plate 310 of the corresponding discharge section D is deflected upward in the drawing. As a result of this, in comparison with an initial state that is shown in FIG. 5A, as shown in FIG. 5B, the capacity of the cavity 320 of the corresponding discharge section D expands. In the state that is shown in FIG. 5B, when a potential, which is shown by the driving signal Vin, is changed, the vibration plate 310 is restored by an elastic restoring force thereof, is displaced downward in the drawing passing the position of the vibration plate 310 in the initial state, and as shown in FIG. 5C, the capacity of the cavity 320 contracts rapidly. At this time, a portion of the ink, which the cavity 320 is filled with, discharged as ink droplets from the nozzle N, which is in communication with the cavity 320 as a result of a compression pressure, which is generated inside the cavity 320.

The vibration plate 310 of the discharge section D is driven by the driving signal Vin in the manner that is shown in FIGS. 5A to 5C, and vibrates after being displaced in a vertical direction. The vibration also remains after the driving of the discharge section D due to the driving signal Vin. It is assumed that such residual vibrations, which remain in the discharge section D after the driving of the discharge section D due to the driving signal Vin, include a natural vibration frequency, which is determined by an acoustic resistance Res due to the shapes of the nozzle N and the ink supply opening 360, or the viscosity of the ink, an inertance Int due to an ink weight inside a flow channel, and a compliance Cm of the vibration plate 310. Hereinafter, a calculation model of the residual vibrations that occur in the vibration plate 310 of the discharge section D will be described on the basis of the corresponding assumption.

FIG. 6 is a circuit diagram that shows a simple harmonic motion model, in which residual vibrations of the vibration plate 310 are assumed. In this manner, the calculation model of the residual vibrations of the vibration plate 310 can be represented by an acoustic pressure Prs, and the abovementioned inertance Int, compliance Cm, and acoustic resistance Res. Further, if a step response when the acoustic pressure Prs is applied to the circuit of FIG. 6, is calculated with respect to a volume velocity Uv, the following equation is obtained.

Uv={Prs/(ω·Int)}e^{-σt}−sin(ωt)

ω={1/(Int·Cm)−γ²}^{1/2}

σ=Res/(2·Int)

A calculation result (a calculated value) that is obtained from the equation, and an experimental result (an experiment value) in an experiment of the residual vibrations of the discharge section D which is performed separately, are compared. Additionally, the experiment of the residual vibrations is an experiment that detects the residual vibrations that occur in the vibration plate 310 of a discharge section D, in which the discharge state of the ink is normal, after ink is discharged from the corresponding discharge section D.

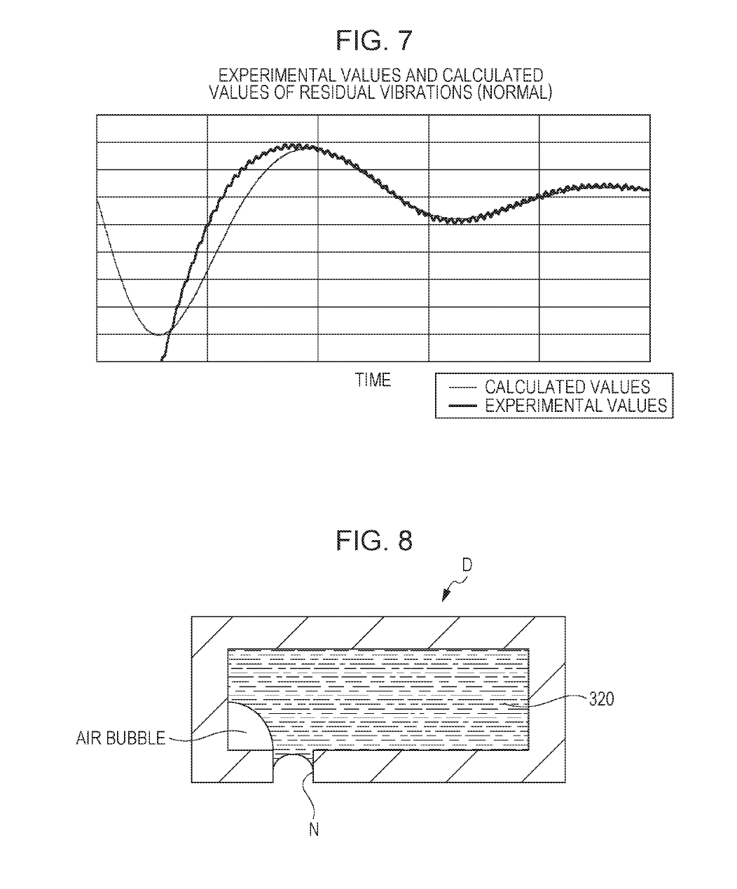

FIG. 7 is a graph that shows a relationship between experimental values and calculated values of the residual vibrations. As can be understood from the graph that is shown in FIG. 7, in a case in which the discharge state of the ink in the discharge section D is normal, the two waveforms of the experimental values and the calculated values generally coincide.

Further, irrespective of whether or not the discharge section D performed an ink discharge action, there are cases in which the discharge state of the ink in the corresponding discharge section D is abnormal, and the ink droplets are not discharge normally from the nozzle N of the corresponding discharge section D, that is, a discharge abnormality occurs. Examples of possible causes of a discharge abnormality occurring include (1) the incorporation of an air bubble inside the cavity 320, (2) thickening or fixing of the ink inside the cavity 320 that is caused by drying of the ink inside the cavity 320, (3) the adherence of foreign matter such as paper dust to the vicinity of the outlet of the nozzle N, and the like.

In the abovementioned manner, a discharge abnormality is when a state in which it is not possible to discharge the ink from the nozzle N in a typical manner, that is, a non-discharge phenomenon occurs, and in such a case, dot omission of the pixels in the image that is printed on the recording sheets P, occurs. In addition, in the abovementioned manner, in a case of a discharge abnormality, even if the ink is discharged from the nozzle N, dot omission of the pixels still occurs since the ink does not land accurately as a result the amount of the ink being too small, the flight direction (trajectory) of the discharged ink droplets being shifted or the like.

Hereinafter, on the basis of the comparison results that are shown in FIG. 7, at least either one of the acoustic resistance Res and the inertance Int will be adjusted for each cause of a discharge abnormality that occurs in the discharge section D so that the calculated values and the experiment values generally coincide.

Firstly, (1) the incorporation of an air bubble inside the cavity 320, which is a cause of a discharge abnormality, will be examined. FIG. 8 is a schematic diagram for describing a case in which an air bubble is incorporated inside the cavity 320. As shown in FIG. 8, in a case in which an air bubble is incorporated inside the cavity 320, a total weight of ink that the inside of the cavity 320 is filled with, is reduced, and therefore, it is thought that the inertance Int decreases. In addition, in a case in which an air bubble is adhered to the vicinity of the of the nozzle N, a state in which it is supposed that the diameter of the N is increase by the diameter of the air bubble, is attained, and therefore, it is thought that the acoustic resistance Res decreases.

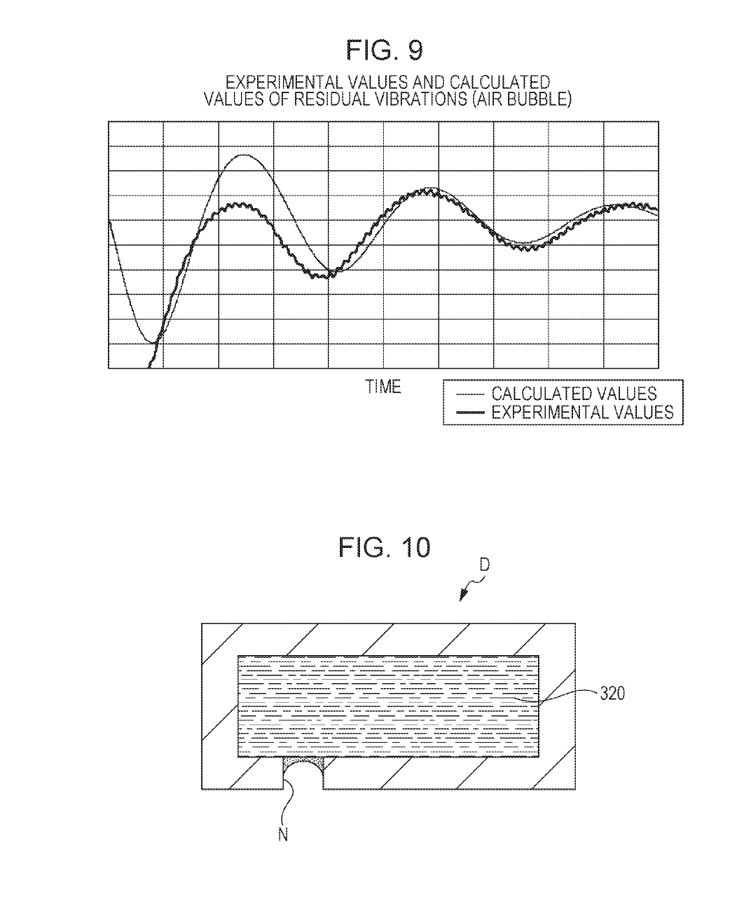

In such an instance, a graph such as that of FIG. 9 is obtained by comparing with a case in which the discharge state of the ink is normal in the manner that is shown in FIG. 7, setting the acoustic resistance Res and the inertance Int to be small, and matching to experiment values of the residual vibrations when an air bubble is incorporated. As shown in FIGS. 7 and 9, in a case in which an air bubble is incorporated inside the cavity 320 and a discharge abnormality occurs, the frequency of the residual vibrations is higher than a case in which the discharge state is normal. Additionally, a dampening rate of the amplitude of the residual vibrations is also reduced as a result of the reduction in the acoustic resistance Res, and the like, and it is possible to confirm that the amplitude thereof is gradually lowered.

Next, (2) thickening or fixing of the ink inside the cavity 320, which is a cause of a discharge abnormality, will be examined. FIG. 10 is a schematic diagram for describing a case in which the ink in the vicinity of the nozzle N of the cavity 320 becomes fixed due to drying. As shown in FIG. 10, in a case in which the ink in the vicinity of the nozzle N becomes fixed due to drying, a circumstance in which the ink inside the cavity 320 is closed-in inside the cavity 320 is reached. In such a case, it is thought that the acoustic resistance Res increases.

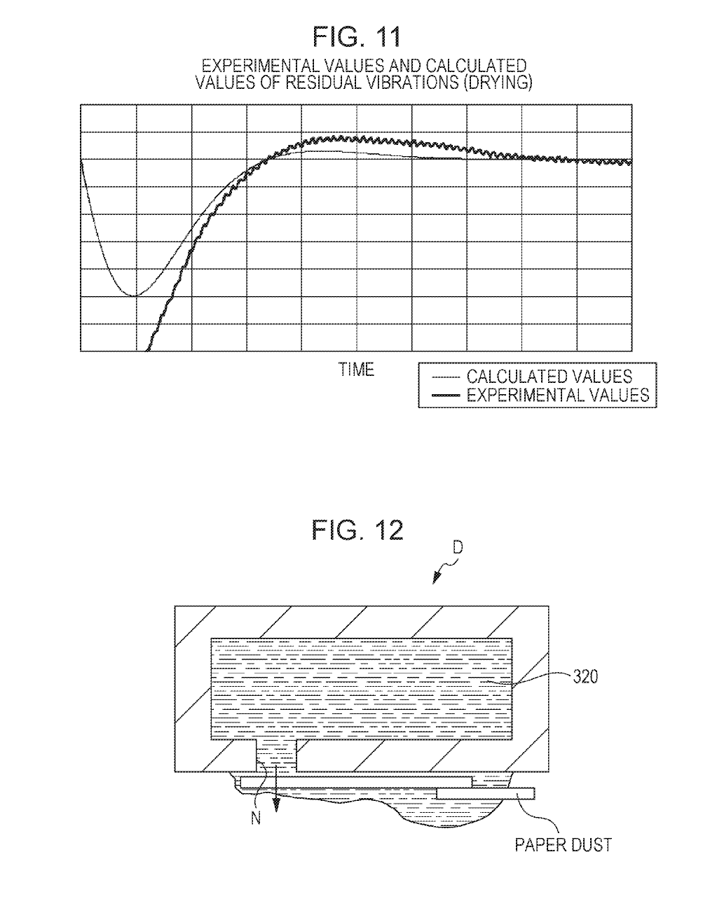

In such an instance, a graph such as that of FIG. 11 is obtained by comparing with a case in which the discharge state of the ink is normal in the manner that is shown in FIG. 7, setting the acoustic resistance Res to be large, and matching to experiment values of the residual vibrations in a case in which the ink in the vicinity of the nozzle N becomes fixed or thickens. Additionally, the experiment values that are shown in FIG. 11 are values in which the residual vibrations of the vibration plate 310, which a discharge section D is provided with, are measured in a state in which the corresponding discharge section D is left in a state in which a cap (not illustrated in the drawing) is not installed, and the ink in the vicinity of the nozzle N becomes fixed. As shown in FIGS. 7 and 11, in a case in which the ink in the vicinity of the nozzle N becomes fixed inside the cavity 320, in comparison with a case in which the discharge state is normal, the frequency of the residual vibrations is considerably low, and a characteristic waveform, in which the residual vibrations are overdampened, is obtained. The reason for this is that the vibration plate 310 suddenly becomes incapable of vibrating (is over dampened) in order for there to be no means of escape for the ink inside the cavity 320 when the vibration plate 310 moves in the −Z direction (downward) after the ink flows into the inside of the cavity 320 from the reservoir as a result of the vibration plate 310 being drawn in the +Z direction (upward) in order to discharge the ink.

Next, (3) the adherence of foreign matter such as paper dust to the vicinity of the outlet of the nozzle N, which is a cause of a discharge abnormality, will be examined. FIG. 12 is a schematic diagram for describing a case in which paper dust becomes adhered to the vicinity of the outlet of the nozzle N. As shown in FIG. 12, in a case in which paper dust becomes adhered to the vicinity of the outlet of the nozzle N, the ink seeps out from inside the cavity 320 through the paper dust, and it is not possible to discharge the ink from the nozzle N. In a case in which paper dust is adhered to the vicinity of the outlet of the nozzle N, and the ink seeps out from the nozzle N, it is thought that the inertance Int increases as a result of the ink the amount of the ink that seeps out from inside the cavity 320 from the vibration plate 310 side becoming greater than that of a case in which the discharge state is normal. In addition, it is though that the acoustic resistance Res also increases as a result of the fibers of paper dust that is adhered to the vicinity of the outlet of the nozzle N.

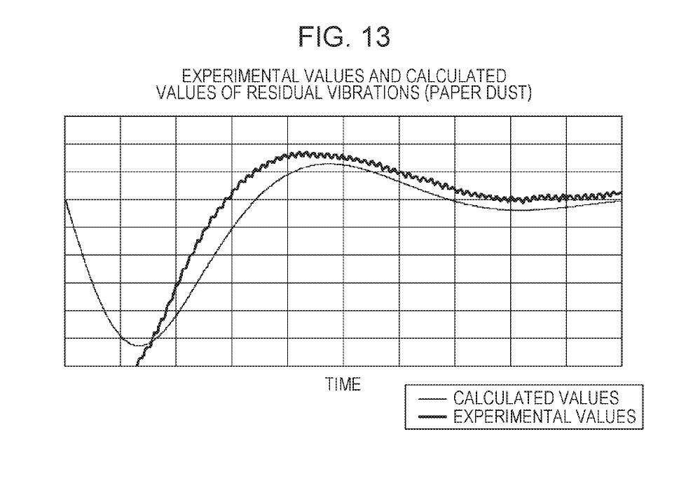

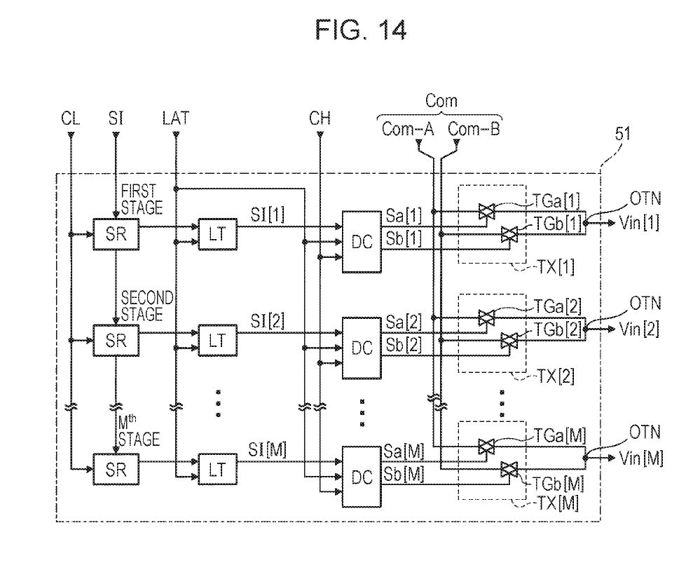

In such an instance, a graph such as that of FIG. 13 is obtained by comparing with a case in which the discharge state of the ink is normal in the manner that is shown in FIG. 7, setting the inertance Int and the acoustic resistance Res to be large, and matching to experiment values of the residual vibrations when paper dust is adhered to the vicinity of the outlet of the nozzle N. As shown in FIGS. 7 and 13, in a case in which paper dust is adhered to the vicinity of the outlet of the nozzle N, the frequency of the residual vibrations is lower than a case in which the discharge state is normal.

Additionally, from the graphs that are shown in FIGS. 11 and 13, it can be understood that the of the residual vibrations is higher in the case of (3) the adherence of foreign matter such as paper dust to the vicinity of the outlet of the nozzle N than in the case of (2) the thickening of the ink inside the cavity 320.

In this instance, in both the case of (2) the thickening of the ink, and the case of (3) the adherence of paper dust to the vicinity of the outlet of the nozzle N, the frequency of the residual vibrations is lower than a case in which the discharge state of the ink in is normal. It is possible to discriminate between these two causes of discharge abnormalities by comparing the waveforms of the residual vibrations, or more specifically, the frequencies or the periods of the residual vibrations with a threshold value that is established in advance.

As is evident from the abovementioned explanation, it is possible to determine the discharge state of the discharge section D on the basis of the waveform of the residual vibrations, which occur when the discharge section D is driven, and in particular, the frequency or the period of the residual vibrations. More specifically, on the basis of the frequency or the period of the residual vibrations, it is possible to determine whether or not the discharge state in the discharge section D is normal, and which if the abovementioned (1) to (3) the cause of a corresponding discharge abnormality corresponds to in a case in which the discharge state in the discharge section D is abnormal. The ink jet printer 1 of the present embodiment executes a discharge state determination process, which determines the discharge state by analyzing residual vibrations.

### 4. Configuration and Actions of Head Driver

Next, the head driver 5 (the driving signal creation section 51, the detection signal creation section and the connection section 53) and the discharge state determination section 4, will be described with reference to FIGS. 14 to 24.

### 4.1. Driving Signal Creation Section

FIG. 14 is a block diagram that shows a configuration of the driving signal creation section 51 in the head driver 5.

As shown in FIG. 14, the driving signal creation section 51 includes M groups, which are formed from a shift register SR, a decoder DC, and a switching section TX to correspond to the M discharge sections D on a one-to-one basis. Hereinafter, each element that configures the M groups will be referred to as a first stage, a second stage, . . . , and an M^{th} stage in order from the top in the drawing.

The clock signal CL, the printing signal SI, a latch signal LAT, a change signal CH, and the driving waveform signals Com (Com-A and Com-B) are supplied to the driving signal creation section 51 from the control section 6.

The driving waveform signals Com (Com-A and Com-B) are signals that include a plurality of waveforms for driving the discharge sections D.

The printing signal SI is a digital signal that indicates a waveform of the driving waveform signals Com, which are to be supplied to each discharge section D, and as a result of this, indicates the presence or absence of the discharge of ink from each discharge section D, and an ink amount that each discharge section D is to discharge. The printing signal SI includes printing signals SI[1] to SI[M]. Among these, a printing signal SI[m] indicates the presence or absence of the discharge of ink from a discharge section D[m], and the ink amount that a discharge section D[m] is to discharge with two bits of a high order bit b1 and a low order bit b2.

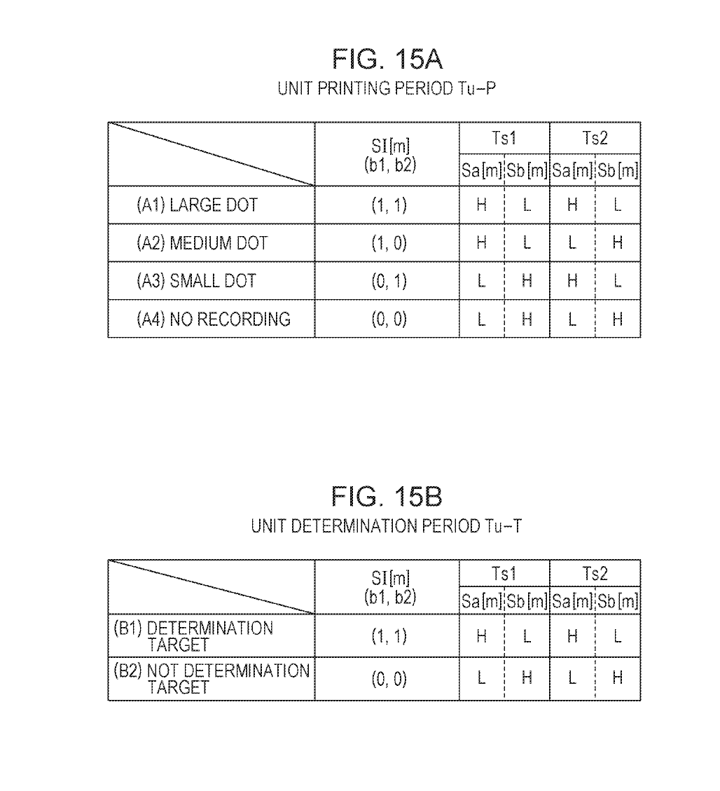

More specifically, in a case in which the ink jet printer 1 is executing a printing process, the printing signal SI[m] indicates either one of the discharge of ink of an amount that corresponds to large dots, the discharge of ink of an amount that corresponds to medium dots, the discharge of ink of an amount that corresponds to small dots, or non-discharge of ink to the discharge section D[m] (refer to FIG. 15A). Meanwhile, in a case in which the ink jet printer 1 is executing a discharge state determination process, the printing signal SI[m] indicates either one of the generation of residual vibrations for the detection of the discharge state in the discharge section D[m], or the generation of micro vibrations for thickening prevention of the ink in the discharge section D[m] (refer to FIG. 15B).

The driving signal creation section 51 supplies the driving signal Vin, which has the waveform that is indicated by the printing signal SI[m], to the discharge section D[m]. Hereinafter, among driving signals Vin, a driving signal Vin, which has the waveform that is indicated by the printing signal SI[m], and is supplied to the discharge section D[m], will be referred to as a driving signal Vin[m].

The shift register SR temporarily maintains the printing signals SI (SI[1] to SI[M]), which are supplied in serial, for each two bits that correspond to each discharge section D. More specifically, the shift register SR has a configuration in which M shift registers SR of the first stage, the second stage, . . . , and the M^{th} stage, which correspond to the M discharge sections D on a one-to-one basis, are cascade connected with one another, and sequentially transmits the supplied printing signals SI to later stages in accordance with the clock signal CL.

Further, when the printing signals SI are transmitted by all of the M shift registers SR, a state in which, among the printing signals SI, the M shift registers SR respectively maintain data of two bits, which correspond to themselves, is retained. Hereinafter, there are cases in which an m^{th} stage shift register SR is referred to as a shift register SR[m].

M latch circuits LT respectively latch the two-bit printing signals SI[m], which are respectively maintained by the M shift registers SR, and correspond to each stage, in a concurrent manner at a timing at which the latch signal LAT rises. That is, the latch circuit LT of the m^{th} stage latches the printing signal SI[m], which is maintained by the shift register SR[m].

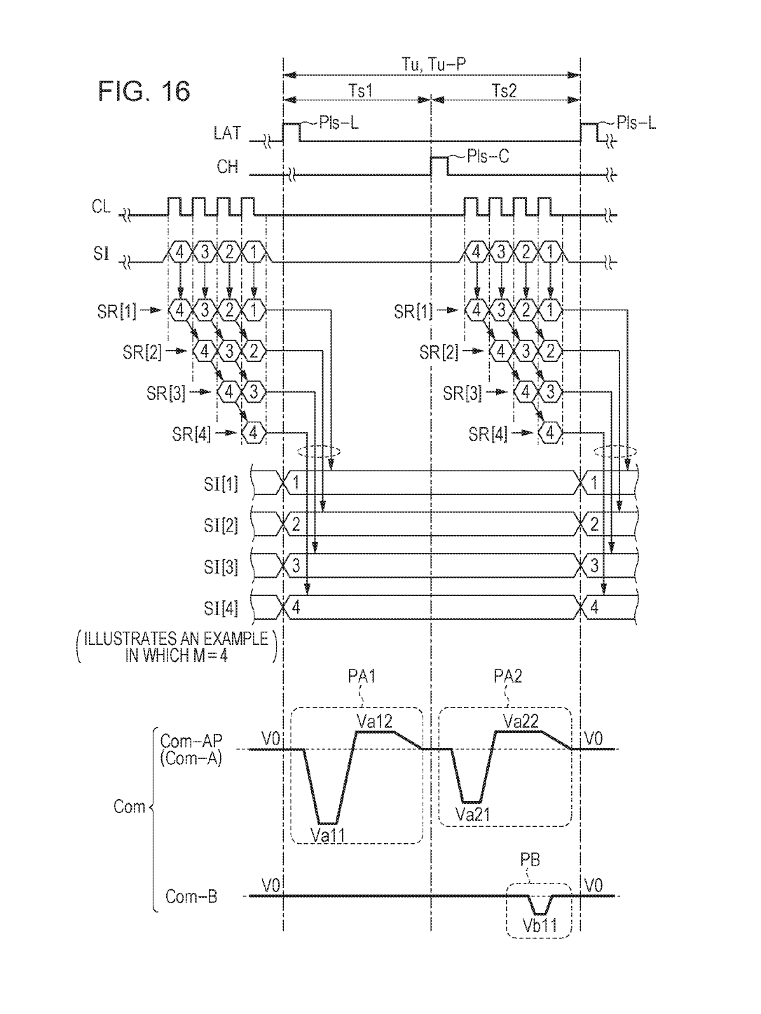

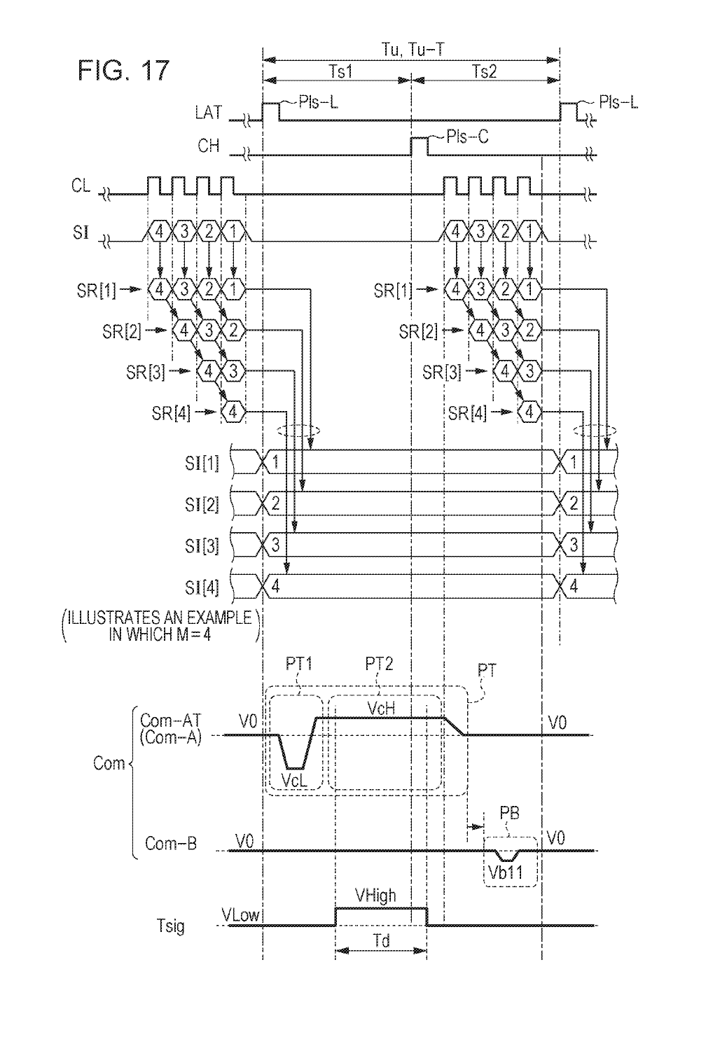

Given that, action periods, which are periods in which the ink jet printer 1 executes at least one process of the printing process and the discharge state determination process, are configured from a plurality of unit periods Tu. In addition, in the present embodiment, the unit periods Tu are classified into two types of unit period Tu of a unit printing period Tu-P (refer to FIG. 16), which is a unit period Tu in which the printing process is executed, and a unit determination period Tu-T, which is a unit period Tu in which the discharge state determination process is executed (refer to FIG. 17).

In the abovementioned manner, after dividing longitudinal recording sheets P into a plurality of printing regions, and a plurality of blank space regions for respectively partitioning the plurality of printing regions, the ink jet printer 1 according to the present embodiment forms a single image in each printing region.

More specifically, the control section 6 controls the actions of each section of the ink jet printer 1 so that, among the plurality of unit periods Tu that configure the action periods, periods in which at least a portion of a printing region of the recording sheets P is positioned on a lower side (the −Z side) of the recording head 3, are classified as unit printing periods Tu-P, and the printing process is executed in the unit printing periods Tu-P.

Meanwhile, the control section 6 controls the actions of each section of the ink jet printer 1 so that, among the plurality of unit periods Tu that configure the action periods, periods in which only a blank space region of the recording sheets P are positioned on a lower side (the −Z side) of the recording head 3, are classified as unit determination periods Tu-T, and the discharge state determination process is executed in the unit printing periods Tu-T.

In addition, the control section 6 supplies the printing signals SI to the driving signal creation section for each unit period Tu, and supplies the latch signal LAT in a manner in which the latch circuit LT latches the printing signal SI[m] for each unit period Tu.

More specifically, in the unit printing periods Tu-P, the control section 6 controls the driving signal creation section 51 so that a printing process driving signal Vin for executing the printing process is supplied to each discharge section D[m]. In this instance, the printing process driving signal Vin is a driving signal Vin for driving the discharge sections D so that the corresponding discharge sections D execute either one of the discharge of ink of an amount that corresponds to large dots, the discharge of ink of an amount that corresponds to medium dots, the discharge of ink of an amount that corresponds to small dots, or non-discharge of ink.

In addition, in the unit determination periods Tu-T, the control section 6 controls the driving signal creation section 51 so that a discharge state determination process driving signal Vin for executing the discharge state determination process is supplied to each discharge section D[m]. In this instance, the discharge state determination process driving signal Vin is a driving signal Vin for driving the discharge sections D so that residual vibrations or micro vibrations occur in the corresponding discharge sections D.

Additionally, in the present embodiment, the control section 6 splits the unit periods Tu into a control period Ts1 and a control period Ts2 using the change signal CH. The control periods Ts1 and Ts2 include mutually equivalent durations. Hereinafter, the control periods Ts1 and Ts2 will be referred to as a control period Ts.

The decoder DC decodes the printing signals SI[m] that are latched by the latch circuits LT, and outputs selection signals Sa[m] and Sb[m].

FIGS. 15A and 15B are explanatory drawings that show decoding contents of the decoder DC in each unit period Tu. Among these, FIG. 15A shows the decoding contents of a decoder DC of the m^{th} stage in the unit printing period Tu-P, and FIG. 15B shows the decoding contents of a decoder DC of the m^{th} stage in the unit determination period Tu-T.

As shown in FIGS. 15A and 15B, in the unit printing periods Tu-P and Tu-T, the decoder DC of the m^{th} stage respectively outputs the selection signals Sa[m] and Sb[m] in the control periods Ts1 and Ts2. For example, in a case in which the printing signal SI[m] is (b1, b2)=(1, 0) in the unit printing period Tu-P (refer to (A2) in FIG. 15A), the decoder DC of the m^{th} stage respectively sets the selection signal Sa[m] to a high level H and the selection signal Sb[m] to a low level L in the control period Ts1, and respectively sets the selection signal Sb[m] to a high level H and the selection signal Sa[m] to a low level L in the control period Ts2.

As shown in FIG. 14, the driving signal creation section 51 is provided with M switching sections TX in a manner that corresponds to the M discharge sections D on a one-to-one basis. A switching section TX[m] of the m^{th} stage is provided with a transmission gate TGa[m], which is turned on when the selection signal Sa[m] is at an H level, and turned off when the selection signal Sa[m] is at an L level, and a transmission gate TGb[m], which is turned on when the selection signal Sb[m] is at an H level, and turned off when the selection signal Sb[m] is at an L level.

For example, in a case in which the printing signal SI[m] shows (1, 0) in the unit printing period Tu-P (refer to (A2) in FIG. 15A), in the control period Ts1, the transmission gate TGa[m] is turned on, and the transmission gate TGb[m] is turned off, and thereafter, in the control period Ts2, the transmission gate TGa[m] is turned off, and the transmission gate TGb[m] is turned on.

As shown in FIG. 14, the driving waveform signal Com-A is supplied to an end of the transmission gate TGa[m], and the driving waveform signal Com-B is supplied to an end of the transmission gate TTGb[m]. In addition, the other ends of the transmission gates TGa[m] and TGb[m] are electrically connected to an output end OTN of the m^{th} stage.

In addition, as shown in FIGS. 15A and 15B, in each control period Ts, the switching section TX[m] is controlled so that one of the transmission gates TGa[m] and TGb[m] is on and the other is off. In other words, the switching section TX[m] supplies either one of the driving waveform signals Com-A or Com-B to the discharge section D[m] as the driving signal Vin[m] via the output end OTN of the m^{th} stage.

### 4.2. Driving Waveform Signal

FIGS. 16 and 17 are timing charts for describing various signals that the control section 6 supplies to the driving signal creation section 51 in each unit period Tu, and actions of the driving signal creation section 51 in each unit period Tu. Among these drawings, FIG. 16 is an example of actions of the driving signal creation section 51 and signals that are supplied to the driving signal creation section 51 in the unit printing period Tu-P, and FIG. 17 is an example of actions of the driving signal creation section and signals that are supplied to the driving signal creation section 51 in the unit determination period Tu-T. Additionally, in FIGS. 16 and 17, a case in which M=4 is illustrated by way of example for the convenience of illustration.

As shown in FIGS. 16 and 17, the unit period Tu is split by a pulse Pls-L, which is included in the latch signal LAT that the control section 6 outputs, and in addition, the control periods Ts1 and Ts2 are split by a pulse Pls-C, which is included in the change signal CH that the control section 6 outputs.

The control section 6 supplies the printing signals SI to the driving signal creation section 51 in synchronization with the clock signals CL before the initiation of each unit period Tu. Further, the shift registers SR of the driving signal creation section 51 sequentially transmit the supplied printing signals SI[m] to later stages in accordance with the clock signals CL.

As shown in FIGS. 16 and 17, the waveform of the driving waveform signal Com-A, which the control section 6 outputs, differs in the unit printing period Tu-P and the unit determination period Tu-T.

Hereinafter, among the driving waveform signals Com-A, a signal that the control section 6 outputs in the unit printing period Tu-P will be referred to as a printing driving waveform signal Com-AP (refer to FIG. 16). In addition, among the driving waveform signals Com-A, a signal that the control section 6 outputs in the unit determination period Tu-T will be referred to as a determination driving waveform signal Com-AT (refer to FIG. 17).

As is illustrated in FIG. 16 by way of example, the printing driving waveform signal Com-AP, which the control section 6 outputs in the unit printing period Tu-P, includes a discharge waveform PA1 (hereinafter, referred to as a “waveform PA1”), which is provided in the control period Ts1, and a discharge waveform PA2 (hereinafter, referred to as a “waveform PA2”), which is provided in the control period Ts2.

The waveform PA1 is a waveform according to which a medium amount of the ink, which is equivalent to a medium dot, is discharged from the discharge section D[m] when the driving signal Vin[m], which includes the waveform PA1, is supplied to the discharge section D[m].

The waveform PA2 is a waveform according to which a small amount of the ink, which is equivalent to a small dot, is discharged from the discharge section D[m] when the driving signal Vin[m], which includes the waveform PA2, is supplied to the discharge section D[m].

For example, a difference in potential between a minimum potential Va11 and a maximum potential Va12 of the waveform PA1 is established so as to be greater than a difference in potential between a minimum potential Va21 and a maximum potential Va22 of the waveform PA2.

As is illustrated in FIGS. 16 and 17 by way of example, the printing driving waveform signal Com-B, which the control section 6 outputs in both unit periods Tu of the unit printing period Tu-P and the unit determination period Tu-T, includes a micro vibration waveform PB (hereinafter, referred to as a “waveform PB”).

The waveform PB is a waveform according to which the ink is not discharged from the discharge section D[m] in a case in which the driving signal Vin[m], which includes the waveform PB is supplied to the discharge section D[m]. In other words, the micro vibration waveform PB is a waveform for preventing the thickening of the ink by applying micro vibrations to the ink inside the discharge sections D. For example, a difference in potential between a minimum potential Vb11 and a maximum potential (a reference potential V0 in this example) of the waveform PB is established so as to be smaller than a difference in potential between the minimum potential Va21 and the maximum potential Va22 of the waveform PA2.

As is illustrated in FIG. 17 by way of example, the determination driving waveform signal Com-AT, which the control section 6 outputs in the unit determination period Tu-T, includes a detection waveform PT (hereinafter, referred to as a “waveform PT”).

The waveform PT includes a waveform PT1 for causing the discharge sections D to vibrate, and a waveform PT2 for retaining the residual vibrations of the discharge sections D after driving due to the waveform PT1.

The waveform PT1 is a waveform according to which the ink is not discharged from the discharge section D[m] in a case in which the driving signal Vin[m], which includes the waveform PT1 is supplied to the discharge section D[m]. For example, a difference in potential between a minimum potential VcL and a maximum potential (a detection potential VcH in this example) of the waveform PT1 is established so as to be smaller than a difference in potential between the minimum potential Va21 and the maximum potential Va22 of the waveform PA2. In other words, it is assumed that the discharge state determination process according to the present embodiment is so-called “non-discharge detection”, which determines the discharge state of the ink in the discharge sections D on the basis of the residual vibrations that occur in the discharge sections D when the corresponding discharge sections D are driven in a manner that does not discharge the ink. However, the waveform PT1 may be a waveform according to which the ink is discharged from the discharge section D[m] in a case in which the driving signal Vin[m], which includes the waveform PT1 is supplied to the discharge section D[m]. In other words, the discharge state determination process may be executed as “discharge detection”.

The waveform PT2 is a level waveform in which the detection potential VcH is kept. By supplying the driving signal Vin[m], which includes the waveform PT2, immediately after the discharge section D[m] is driven due to the driving signal Vin[m], which includes the waveform PT1, it is possible to retain the residual vibrations that occur in the discharge section D[m] as a result of the driving due to the waveform PT1, and therefore, accurate detection of the corresponding residual vibrations is possible.

Among the unit determination period Tu-T in which the driving waveform signal Com-AT is supplied to the discharge section D[m], the detection signal creation section 52 detects the residual vibrations that occur in the discharge section D[m] as the residual vibration signal Vout in a detection period Td that includes a period in which the waveform Pt2 is supplied to the discharge section D[m], and the driving signal Vin[m] retains the detection potential VcH.

In the present embodiment, as shown in FIG. 17, the detection period Td is defined as a period in which a detection period indication signal Tsig, which the control section 6 outputs, is at a predetermined potential VHigh. Additionally, in the present embodiment, the detection period Td is provided before the initiation of the period in which the clock signal CL is supplied and the shift registers SR transmit the printing signals SI[m].

### 4.3. Driving Signals

Next, the driving signals Vin that the driving signal creation section 51 outputs in the unit periods Tu will be described.

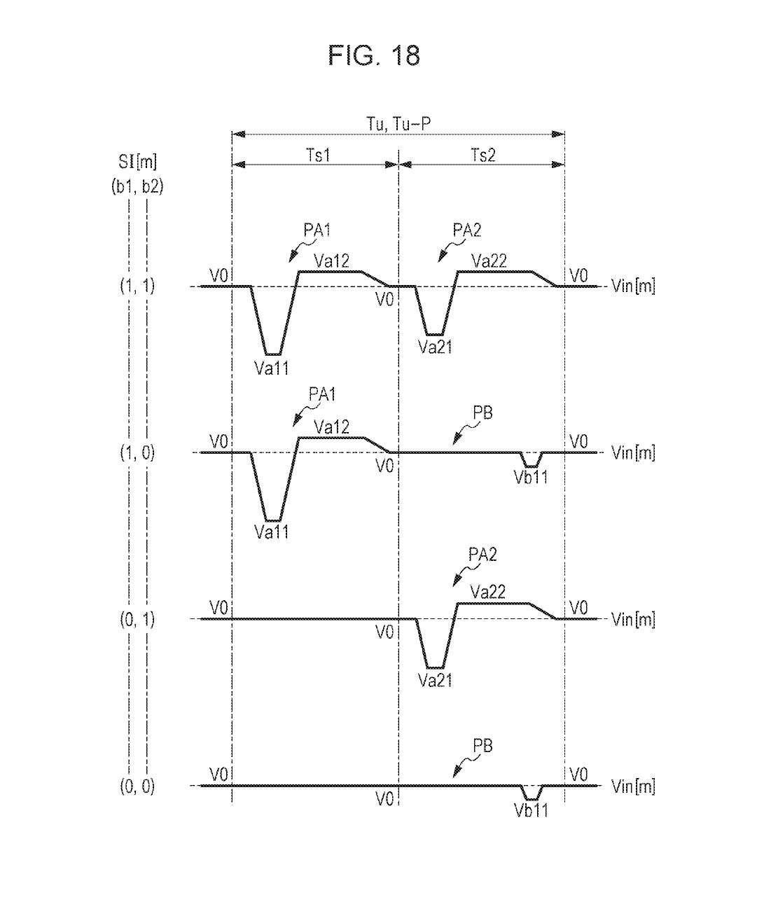

Firstly, the printing process driving signal Vin that the driving signal creation section 51 outputs in the unit printing period Tu-P will be described with reference to FIG. 18.

In a case in which the printing signal SI[m], which is supplied in the unit printing period Tu-P, shows (1, 1), the switching section TX[m] outputs a driving signal Vin[m], which includes the waveform PA1, by selecting the driving waveform signal Com-A in the control period Ts1, and outputs a driving signal Vin[m], which includes the waveform PA2, by selecting the driving waveform signal Com-A in the control period Ts2 (refer to (A1) in FIG. 15A). Accordingly, in this case, as shown in FIG. 18, the driving signal Vin[m], which is supplied to the discharge section D[m] in the unit printing period Tu-P includes the waveform PA1 and the waveform PA2. As a result of this, the discharge section D[m] discharges a medium amount of ink on the basis of the waveform PA1, and a small amount of ink on the basis of the waveform PA2 in the corresponding unit printing period Tu-P, and forms large dots on the recording sheets P as a result the ink that is discharged during the two abovementioned times.

In a case in which the printing signal SI[m], which is supplied in the unit printing period Tu-P, shows (1, 0), the switching section TX[m] outputs a driving signal Vin[m], which includes the waveform PA1, by selecting the driving waveform signal Com-A in the control period Ts1, and outputs a driving signal Vin[m], which includes the waveform PB, by selecting the driving waveform signal Com-B in the control period Ts2 (refer to (A2) in FIG. 15A). Accordingly, in this case, as shown in FIG. 18, the driving signal Vin[m], which is supplied to the discharge section D[m] in the unit printing period Tu-P, includes the waveform PA1 and the waveform PB. As a result of this, the discharge section D[m] discharges a medium amount of the ink on the basis of the waveform PA1 in the corresponding unit printing period Tu-P, and forms medium dots on the recording sheets P.

In addition, in a case in which the printing signal SI[m], which is supplied in the unit printing period Tu-P, shows (0, 1), the switching section TX[m] outputs a driving signal Vin[m], which includes the waveform PB, by selecting the driving waveform signal Com-B in the control period Ts1, and outputs a driving signal Vin[m], which includes the waveform PA2, by selecting the driving waveform signal Com-A in the control period Ts2 (refer to (A3) in FIG. 15A). Accordingly, in this case, as shown in FIG. 18, the driving signal Vin[m], which is supplied to the discharge section D[m] in the unit printing period Tu-P, includes the waveform PA2. As a result of this, the discharge section D[m] discharges a small amount of the ink on the basis of the waveform PA2 in the corresponding unit printing period Tu-P, and forms small dots on the recording sheets P.

In addition, in a case in which the printing signal SI[m], which is supplied in the unit printing period Tu-P, shows (0, 0), the switching section TX[m] outputs a driving signal Vin[m], which includes the waveform PB, by selecting the driving waveform signal Com-B in the control periods Ts1 and Ts2 (refer to (A4) in FIG. 15A). In other words, in this case, as shown in FIG. 18, the driving signal Vin[m], which is supplied to the discharge section D[m] in the unit printing period Tu-P, includes the waveform PB. As a result of this, the discharge section D[m] does not discharge the ink in the corresponding unit printing period Tu-P, and dots are not formed on the recording sheets P (non-discharge).

Next, the discharge state determination process driving signal Vin that the driving signal creation section outputs in the unit determination period Tu-T will be described.

Firstly, in a case in which the printing signal SI[m], which is supplied in the unit determination period Tu-T, shows (1, 1), the switching section TX[m] supplies a driving signal Vin[m], which includes the waveform PT to the discharge section D[m], by selecting the driving waveform signal Com-A in the control periods Ts1 and Ts2 (refer to (B1) in FIG. 15B).

In addition, in a case in which the printing signal SI[m], which is supplied in the unit determination period Tu-T, shows (0, 0), the switching section TX[m] supplies a driving signal Vin[m], which includes the waveform PB to the discharge section D[m], by selecting the driving waveform signal Com-B in the control periods Ts1 and Ts2 (refer to (B2) in FIG. 15B).

In a case in which the discharge section D[m] is set as a target of the discharge state determination process in one unit determination period Tu-T, the control section 6 sets a value of the printing signal SI[m] to (1, 1) so that a driving signal Vin[m], which includes the waveform PT, is supplied to the discharge section D[m] in the corresponding one unit determination period Tu-T.

In addition, in a case in which the discharge section D[m] is set as a target of the discharge state determination process in one unit determination period Tu-T, the control section 6 sets a value of the printing signal SI[m] to (0, 1) so that a driving signal Vin[m], which includes the waveform PB, is supplied to the discharge section D[m] in the corresponding one unit determination period Tu-T.

### 4.4. Connection Section

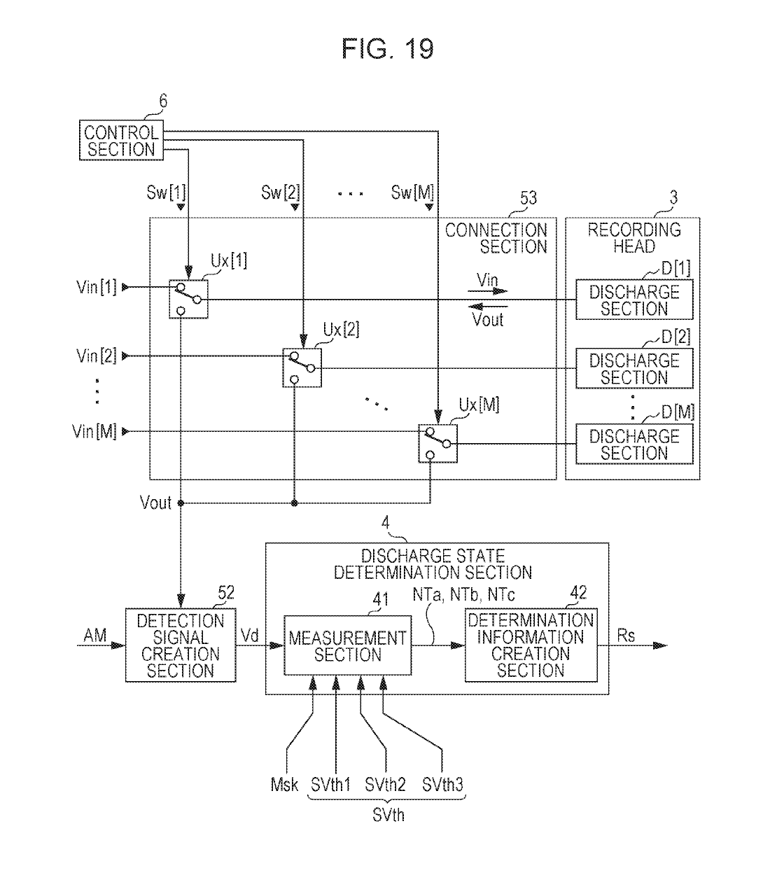

FIG. 19 is a block diagram that shows an example of the configurations of the connection section 53 and the discharge state determination section 4, and a connection relationship between the recording head 3, the connection section 53, the detection signal creation section 52, and the discharge state determination section 4.

As is illustrated by way of example in FIG. 19, the connection section 53 is provided with M connection circuits Ux (Ux[1], Ux[2], . . . , and Ux[M]) of the first stage to the M^{th} stage, which corresponds to the M discharge sections D on a one-to-one basis. A connection circuit Ux[m] of the m^{th} stage electrically connects the upper section electrode 302 of the piezoelectric element 300 of the discharge section D[m] to either one of the output end OTN of the m^{th} stage, which the driving signal creation section 51 is provided with, and the detection signal creation section 52.

Hereinafter, a state in which the connection circuit Ux[m] electrically connects the discharge section D[m] and the output end OTN of the m^{th} stage of the driving signal creation section 51 will be referred to as a first connection state. In addition, a state in which the connection circuit Ux[m] electrically connects the discharge section D[m] and the detection signal creation section 52 will be referred to as a second connection state.

The control section 6 outputs a connection control signal Sw for controlling the connection state of each connection circuit Ux, to each connection circuit Ux.

More specifically, the control section 6 supplies a connection control signal Sw[m] according to which the connection circuit Ux[m] retains the first connection state throughout the entire period of the unit printing period Tu-P, to the connection circuit Ux[m] in the unit printing period Tu-P. Therefore, the driving signal Vin[m] is supplied to the discharge section D[m] from the driving signal creation section 51 throughout the entire period of the unit printing period Tu-P.

In addition, in a case in which the discharge section D[m] is the target of the discharge state determination process in the unit determination period Tu-T, the control section 6 supplies a connection control signal Sw[m] according to which, in the corresponding unit determination period Tu-T, the connection circuit Ux[m] attains the first connection state in periods other than the detection period Td, and attains the second connection state in the detection period Td, to the connection circuit Ux[m]. Therefore, in a case in which the discharge section D[m] is the target of the discharge state determination process in the unit determination period Tu-T, the driving signal Vin[m] is supplied to the discharge section D[m] from the driving signal creation section 51 in periods other than the detection period Td in the corresponding unit determination period Tu-T, and the residual vibration signal Vout is supplied to the detection signal creation section 52 from the discharge section D[m] in the detection period Td in the corresponding unit determination period Tu-T.

In addition, in a case in which the discharge section D[m] is not a target of the discharge state determination process in the unit determination period Tu-T, the control section 6 supplies the connection control signal Sw[m], according to which the connection circuit Ux[m] retains the first connection state throughout the entire period of corresponding the unit determination period Tu-T, to the connection circuit Ux[m].

Additionally, in the present embodiment, as shown in FIG. 19, a case in which the ink jet printer 1 is provided with a single detection signal creation section 52 only with respect to the M discharge sections D, and, in addition, in which each detection signal creation section 52 is capable detecting the residual vibrations that occur in a single discharge section D only in a single unit period Tu, is assumed. That is, the control section 6 according to the present embodiment controls each section of the ink jet printer 1 so that a single discharge section D from among the M discharge sections D is selected as the target of the discharge state determination process in a single unit determination period Tu-T, and so that the discharge state of the ink in the selected discharge section D is determined.

Therefore, the control section 6 creates the connection control signal Sw so that the discharge section D, which is selected as the target of the discharge state determination process in the unit determination period Tu-T, is set to the second connection state in the detection period Td of the corresponding unit determination period Tu-T, and is electrically connected to the detection signal creation section 52.

### 4.5. Detection Signal Creation Section

In the abovementioned manner, the detection signal creation section 52 that is shown in FIG. 19 creates the detection signal Vd on the basis of the residual vibration signal Vout. In the abovementioned manner, the detection signal Vd is a signal according to which the residual vibration signal Vout is reshaped into a waveform that is suitable for the process in the discharge state determination section 4 by amplifying the amplitude of the residual vibration signal Vout by the amplification factor β, which is indicated by the amplification factor indication signal AM, and, in addition, removing a noise component from the residual vibration signal Vout.

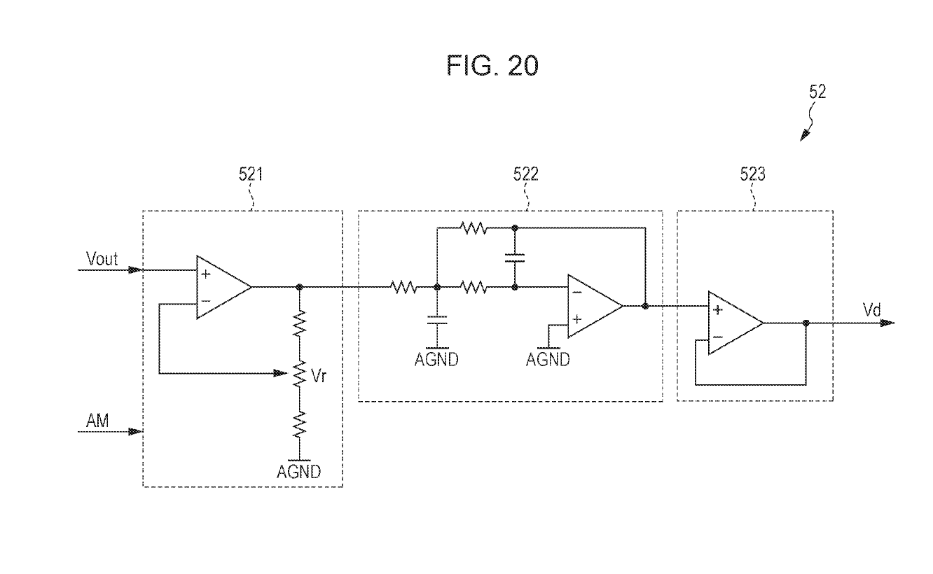

A detailed configuration example of the detection signal creation section 52 is shown in FIG. 20. As shown in the drawing, the detection signal creation section 52 is provided with a gain adjustment section 521, a low pass filter 522, and a buffer 523.

The gain adjustment section 521 is, for example, a negative feedback type amplifier that uses an operational amplifier, and can amplify the residual vibration signal Vout by the amplification factor β by adjusting a resistance value of a variable resistor Vr, which has a resistance such as ladder type resistance, depending on the amplification factor β, which the amplification factor indication signal AM indicates.

The low pass filter 522 dampens high band frequency components of the residual vibration signal Vout. The low pass filter 522 of this example is a multi-feedback type, which uses an operational amplifier, but may be any form of low pass filter as long as high band frequency components are dampened more than a frequency band of the residual vibrations. As a result of the low pass filter 522, it is possible to remove a noise component by limiting a frequency range that is detected.

The buffer 523 outputs a low impedance detection signal Vd by converting the impedance. In this example, the buffer 523 is configured by a voltage follower that uses an operational amplifier.

It is possible to eliminate a noise component from the residual vibration signal Vout, and create a detection signal Vd in which the amplitude of the residual vibration signal Vout is amplified using a detection signal creation section 52 such as that shown in FIG. 20. Therefore, it is possible to accurately determine the discharge state of the ink in the discharge sections D on the basis of the detection signal Vd.

### 4.6. Discharge State Determination Section

The discharge state determination section 4 determines a discharge state of the ink in the discharge sections D on the basis of the detection signal Vd that the detection signal creation section 52 outputs, and creates determination information RS, which shows the corresponding detection result.

As shown in FIG. 19, the discharge state determination section 4 is provided with a measurement section 41, and a determination information creation section 42. The measurement section 41 measures various durations of the residual vibrations that occur in the discharge sections D on the basis of the detection signal Vd, which the detection signal creation section 52 outputs, and creates measurement signals NTa, NTb and NTc, which show the corresponding measurement results. The determination information creation section 42 outputs the determination information RS, which shows the determination results of the discharge state of the ink in the discharge sections D on the basis of the measurement signals NTa, NTb and NTc, which the measurement section 41 outputs. Hereinafter, the details of the measurement section 41 and the determination information creation section 42 will be described.

As shown in FIG. 19, the detection signal Vd is supplied to the measurement section 41 from the detection signal creation section 52, and, in addition, the threshold value signal SVth and a mask signal Msk are supplied from the control section 6.

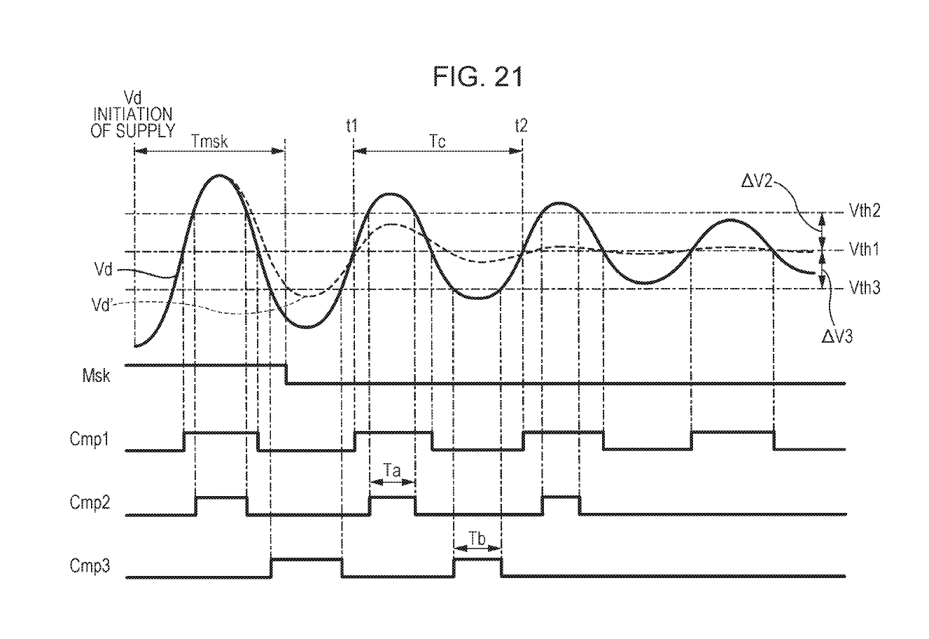

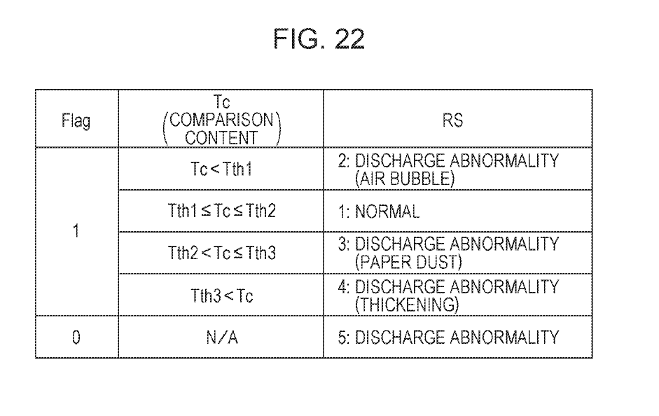

In this instance, the threshold value signal SVth includes a threshold value signal SVth1 that shows a threshold value potential Vth1, which is an amplitude intermediate level of the detection signal Vd, a threshold value signal SVth2 that shows a threshold value potential Vth2, which is a higher potential than the threshold value potential Vth1 by a difference in potential ΔV2, and a threshold value signal SVth3 that shows a threshold value potential Vth3, which is a lower potential than the threshold value potential Vth1 by a difference in potential ΔV3 (refer to FIG. 21).

FIG. 21 is a timing chart that shows actions of the measurement section 41. As shown in the drawing, the measurement section 41 compares the potential that the detection signal Vd shows with the threshold value potential Vth1, and creates a comparison signal Cmp1 which is at a high level in a case in which the potential that the detection signal Vd shows is the threshold value potential Vth1 or more, and is at a low level in a case in which the potential that the detection signal Vd shows is less than the threshold value potential Vth1. In addition, the measurement section 41 compares the potential that the detection signal Vd shows with the threshold value potential Vth2, and creates a comparison signal Cmp2 which is at a high level in a case in which the potential that the detection signal Vd shows the threshold value potential Vth2 or more, and is at a low level in a case in which the potential that the detection signal Vd shows is less than the threshold value potential Vth2. In addition, the measurement section 41 compares the potential that the detection signal Vd shows with the threshold value potential Vth3, and creates a comparison signal Cmp3 which is at a high level in a case in which the potential that the detection signal Vd shows is less than the threshold value potential Vth3, and is at the high level in a case in which the potential that the detection signal Vd shows is the threshold value potential Vth3 or more.

The mask signal Msk is a signal which reaches a high level during a predetermined period Tmsk after the supply of the detection signal Vd from the detection signal creation section 52 is initiated. In the present embodiment, the measurement signals NTa, NTb and NTc, which show corresponding measurement results are created by measuring various durations with only the detection signal Vd after the passage of the period Tmsk set as a target. Therefore, it is possible to reduce the effect of a noise component, which is superimposed immediately after the initiation of the residual vibrations, and therefore, it is possible to obtain high precision measurement signals NTa, NTb and NTc.

In this instance, the measurement signal NTc is a signal that shows a period Tc of a single cycle of the detection signal Vd, the measurement signal NTa is a signal that shows a period Ta, in which a potential that shows the detection signal Vd is the threshold value Vth2 or more, and the measurement signal NTb is a signal that shows a period Tb, in which a potential that shows the detection signal Vd is less than the threshold value Vth3.

The measurement section 41 is provided with a first counter for measuring the period Tc, a second counter for measuring the period Ta, and a third counter for measuring the period Tb (not illustrated in the drawing).

The first counter counts a clock signal from a time point t1, which is a timing with which a potential that the detection signal Vd shows initially becomes equivalent to the threshold value potential Vth1 after the mask signal Msk falls to a low level, to a time point t2, which is a timing with which a potential that the detection signal Vd shows becomes equivalent to the threshold value potential Vth1 for the second time. Further, the first counter outputs an obtained count value as the measurement signal NTc, which shows the period Tc of a single cycle of the detection signal Vd.

Among the period from the time point t1 to the time point t2, the second counter measures the period Ta, in which a potential that the detection signal Vd shows becomes the threshold value Vth2 or more, and the comparison signal Cmp2 is at a high level, and outputs the measurement signal NTa, which shows the corresponding period Ta.

Among the period from the time point t1 to the time point t2, the third counter measures the period Tb, in which a potential that the detection signal Vd shows becomes less than the threshold value Vth3, and the comparison signal Cmp3 is at a high level, and outputs the measurement signal NTb, which shows the corresponding period Tb.

In the abovementioned manner, the determination information creation section 42 outputs the determination information RS, which shows the determination results of the discharge state of the ink in the discharge sections D on the basis of the measurement signals NTa, NTb and NTc, which the measurement section 41 outputs.

More specifically, the determination information creation section 42 determines whether or not the amplitude of the detection signal Vd is included in a predetermined range on the basis of the measurement signals NTa and NTb, and executes a first process, which creates an effective flag Flag that shows a result of the corresponding determination. Further, the determination information creation section 42 determines the discharge state in the discharge sections D on the basis of the effective flag Flag and the measurement signal NTc, and executes a second process, which creates the determination information RS, which shows a result of the corresponding determination.

Firstly, the first process of the determination information creation section 42 will be described in detail.

In a case in which the period Ta, which the measurement signal NTa shows, fulfills “Ta1≦Ta≦Ta2”, and the period Tb, which the measurement signal NTb shows, fulfills “Tb1≦Tb≦Tb2”, the determination information creation section 42 sets a value of the effective flag Flag to a value “1”, which shows that the amplitude of the detection signal Vd is included in a predetermined range. In this instance, the Ta1 and the Ta2 are real numbers that satisfy 0<Ta1<Ta2, and the Tb1 and the Tb2 are real numbers that satisfy 0<Tb1<Tb2. On the other hand, in a case in which the period Ta does not fulfill “Ta1≦Ta≦Ta2”, and the period Tb does not fulfill “Tb1≦Tb≦Tb2”, the determination information creation section 42 sets a value of the effective flag Flag to a value “0”, which shows that the amplitude of the detection signal Vd is not included in the predetermined range.

As is illustrated by way of example by the broken line Vd′ in FIG. 21, in a case in which the amplitude of the detection signal Vd is small enough so that the residual vibrations of the amplitude that depends on the driving signal Vin do not occur in the discharge sections D, it is assumed that some other defect such as the ink seeping out from the cavity 320, or malfunctioning of the discharge sections D, occurs in the discharge sections D as a result.

In the present embodiment, it is determined whether or not the detection signal Vd has an appropriate amplitude on the basis of the measurement signals NTa and NTb, and the effective flag Flag, which shows a determination result is created. Therefore, it is possible to understand a discharge abnormality that occurs in the discharge sections D as a result malfunctioning of the discharge sections D or the like.

Additionally, the first process that is mentioned above is merely an example, and the invention is not limited to such an aspect. For example, in a case in which the period Ta, which the measurement signal NTa shows, fulfills “Ta>0”, and the period Tb, which the measurement signal NTb shows, fulfills “Tb>0”, that is, in a case in which the amplitude of the detection signal Vd is larger than an amplitude that is shown by the threshold values Vth2 and Vth3, the determination information creation section 42 may set the value of the effective flag Flag to the value “1”.

Next, the second process of the determination information creation section 42 will be described in detail.

In the abovementioned manner, the determination information creation section 42 determines the discharge state in the discharge sections D on the basis of the effective flag Flag and the measurement signal NTc, and creates the determination information RS, which shows the corresponding determination result, as the second process.

FIG. 22 is an explanatory diagram for describing the content of the determination in the second process that the determination information creation section 42 executes. As is shown in the drawing, the determination information creation section 42 compares the period Tc, which the measurement signal NTc shows, with a portion of or all of three threshold values of a threshold value Tth1, a threshold value Tth2, and a threshold value Tth3. In this instance, the threshold value Tth1 is a value for showing a boundary between a duration of a single cycle of the residual vibrations in a case in which the frequency of the residual vibrations is increased due to an air bubble being generated inside the cavity 320, and a duration of a single cycle of the residual vibrations in a case in which the discharge state is normal. In addition, the threshold value Tth2 is a threshold value that represents a duration that is longer than the threshold value Tth1, and is a value for showing a boundary between a duration of a single cycle of the residual vibrations in a case in which the frequency of the residual vibrations is reduced due to foreign matter such as paper dust being adhered to the vicinity of the outlet of a nozzle N, and a duration of a single cycle of the residual vibrations in a case in which the discharge state is normal. In addition, the threshold value Tth3 is a threshold value that represents a duration that is longer than the threshold value Tth2, and is a value for showing a boundary between a duration of a single cycle of the residual vibrations in a case in which the frequency of the residual vibrations is reduced beyond that of the case in which foreign matter such as paper dust is adhered as a result of the thickening or the fixing of the ink in the vicinity of the outlet of a nozzle N, and a duration of a single cycle of the residual vibrations in a case in which foreign matter such as paper dust is adhered to the vicinity of the outlet of a nozzle N.

As shown in FIG. 22, in a case in which the value of the effective flag Flag is “1”, and the period Tc, which the measurement signal NTc shows, fulfills “Tth1 Tc Tth2”, the determination information creation section 42 determines that the discharge state of the ink in the discharge sections D is normal, and sets a value “1”, which shows that the discharge state is normal, to the determination information RS.

In addition, in a case in which the value of the effective flag Flag is “1”, and the period Tc fulfills “Tc<Tth1”, the determination information creation section 42 determines that a discharge abnormality has been generated as a result of an air bubble that has occurred in the cavity 320, and sets a value “2”, which shows that a discharge abnormality has been generated as a result of an air bubble, to the determination information RS.

In addition, in a case in which the value of the effective flag Flag is “1”, and the period Tc fulfills “Tth2<Tc≦Tth3”, the determination information creation section determines that a discharge abnormality has been generated as a result of foreign matter such as paper dust becoming adhered to the vicinity of the nozzle N, and sets a value “3”, which shows that a discharge abnormality has been generated as a result of foreign matter such as paper dust, to the determination information RS.

In addition, in a case in which the value of the effective flag Flag is “1”, and the period Tc fulfills “Tth3<Tc”, the determination information creation section 42 determines that a discharge abnormality has been generated as a result of thickening of the ink inside the cavity 320, and sets a value “4”, which shows that a discharge abnormality has been generated as a result of ink thickening, to the determination information RS.

In addition, in a case in which the value of the effective flag Flag is “0”, the determination information creation section 42 sets a value “5”, which shows that a discharge abnormality has been generated as a result of some other defect such as malfunctioning of the discharge sections D, the ink not being injected into the cavity 320 or the like, to the determination information RS.

In the abovementioned manner, the determination information creation section 42 determines the discharge state in the discharge sections D on the basis of the measurement signal NTc and the effective flag Flag, and creates the determination information RS, which shows the corresponding determination result.

The control section 6 stores the determination information RS, which the determination information creation section 42 outputs, in the memory section 60 in association with a stage number of a discharge section D that corresponds to the corresponding determination information RS. Therefore, it is possible to understand whether or not a discharge abnormality has occurred in every discharge section D among the M discharge sections D. As a result of this, by taking the number of discharge sections D in which a discharge abnormality has occurred, and the positions of the discharge sections D in which a discharge abnormality has occurred into consideration, it is possible to execute a maintenance process at a suitable timing. Accordingly, it is possible to prevent a circumstance in which the image quality, which is formed in the printing process deteriorates as a result a discharge abnormality in the discharge sections D.

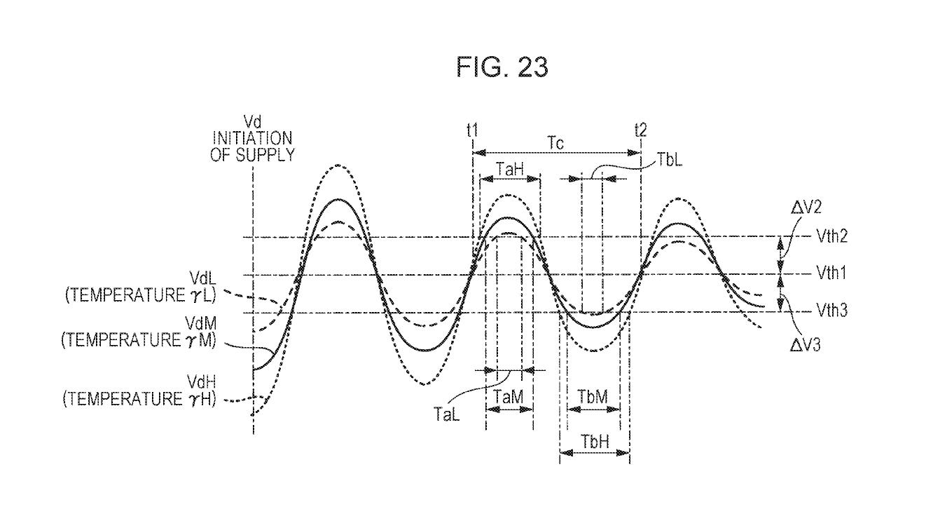

Given that, in addition to changing as a result of a discharge state of the ink in the discharge section D, the amplitude of the detection signal Vd changes as a result of temperature changes in the ink, with which the cavity 320 of the discharge section D is filled. Hereinafter, changes in the amplitude of the detection signal Vd when the temperature γ of the ink, which the discharge section D is filled with, changes will be described with reference to FIG. 23.

FIG. 23 is an explanatory diagram for describing changes in the waveform of the detection signal Vd in a case in which the temperature γ of the ink, which the discharge section D is filled with, changes in a case in which the residual vibration signal Vout is amplified by a fixed amplification factor in the detection signal creation section 52 (a comparative example).

As shown in FIG. 23, even in a case in which the waveform of the detection signal Vd is a waveform VdM when the temperature γ of the ink, with which the discharge section D is filled, is a temperature γM, since the viscosity of the ink becomes low if the temperature γ of the ink becomes a temperature γH, which is a higher temperature than the temperature γM, the waveform of the detection signal Vd becomes a waveform VdH, the amplitude of which is larger than that of the waveform VdM. On the contrary, since the viscosity of the ink becomes high if the temperature γ of the ink becomes a temperature γL, which is a lower temperature than the temperature γM, the waveform of the detection signal Vd becomes a waveform VdL, the amplitude of which is smaller than that of the waveform VdM.

As a result of this, the periods Ta and Tb, which show the measurement signals NTa and NTb, also change as a result temperature changes in the ink, with which the discharge section D is filled. For example, as shown in FIG. 23, even in a case in which the measurement signal NTa shows a period TaM when the waveform of the detection signal Vd is the waveform VdM, if the waveform of the detection signal Vd becomes the waveform VdH, the measurement signal NTa shows a period TaH, which is a longer period than the period TaM, and if the waveform of the detection signal Vd becomes the waveform VdL, the measurement signal NTa shows a period TaL, which is a shorter period than the period TaM. In the same manner, even in a case in which the measurement signal NTb shows a period TbM when the waveform of the detection signal Vd is the waveform VdM, if the waveform of the detection signal Vd becomes the waveform VdH, the measurement signal NTb shows a period TbH, which is a longer period than the period TaM, and if the waveform of the detection signal Vd becomes the waveform VdL, the measurement signal NTb shows a period TbL, which is a shorter period than the period TaM.

Therefore, even in a case in which the effective flag Flag shows the value “1” when the temperature γ of the ink, with which the discharge section D is filled, is the temperature γM, if the amplification factor of the residual vibration signal Vout in the detection signal creation section 52 is constant, the times that the measurement signals NTa and NTb show change as a result of the temperature γ of the ink changing to the temperature γH or the temperature γL, and there are cases in which the effective flag Flag shows the value “0” as a result. In other words, the value of the effective flag Flag changes as a result of the temperature γ of the ink, with which the discharge section D is filled, changing.

However, the reason for the measurement signals NTa and NTb changing in a case in which the temperature γ of the ink changes, is as a result of the changes in the viscosity of the ink and not due to the discharge state in the discharge section D changing from normal to abnormal. In other words, since the temperature γ of the ink, with which the discharge section D is filled, changed irrespective of the fact that the discharge state of the ink in the discharge sections D is normal, the value “0” is set with respect to the effective flag Flag, to which the value “1” should originally to be set. In this case, there is a high probability that the determination information RS, which is created on the basis of the effective flag Flag, will not accurately display the discharge state of the ink in the discharge section D.

In such an instance, in the present embodiment, the amplification factor β, which the amplification factor indication signal AM indicates, is determined on the basis of the temperature α, which the temperature information KT that the temperature sensor 8 outputs, shows, and the detection signal Vd is created by amplifying the residual vibration signal Vout by the corresponding amplification factor β.

The temperature sensor 8 detects the temperature of a predetermined location of the ink jet printer 1, or more specifically, in the present embodiment, detects the temperature of the head unit 10, and outputs the temperature information KT, which shows the corresponding detected temperature α. Further, there is a high probability that the temperature α of the head unit 10 and the temperature γ of the ink, with which the discharge section D is filled, will be different temperatures. However, the temperature γ of the ink propagates to each location of the ink jet printer 1. In other words, if the temperature γ of the ink is high, the temperature α that the temperature sensor 8 detects thereafter is also high, and if the temperature γ of the ink is low, the temperature α that the temperature sensor 8 detects thereafter is also low. Therefore, it is possible to assume the temperature γ of the ink on the basis of the temperature α. Accordingly, it is possible to restrict the degree of change in the amplitude of the detection signal Vd as a result of changes in the temperature γ of the ink, to a small amount by establishing the amplification factor β depending on the temperature α.

FIG. 24 is a diagram that shows a relationship between the temperature α, which the temperature information KT that the temperature sensor 8 outputs, shows, and the amplification factor β, which the amplification factor indication signal AM that the control section 6 outputs, indicates.

As shown in FIG. 24, the control section 6 outputs an amplification factor indication signal AM that indicates “βL” as the amplification factor β in a case in which the temperature α satisfies “αL≦α<α1”, outputs an amplification factor indication signal AM that indicates “βM” as the amplification factor β in a case in which the temperature α satisfies “α1≦α<α2”, and outputs an amplification factor indication signal AM that indicates “βH” as the amplification factor β in a case in which the temperature α satisfies “α2≦α<αH”. In this instance, the temperatures αL, α1, α2, and αH, satisfy “αL<α1<α2<αH”, and the amplification factors βL, βM, and βH, satisfy “βL>βM>βH”. That is, in the present embodiment, the control section 6 creates an amplification factor indication signal AM according to which the amplification factor β decreases in accordance with increases in the temperature α.

Therefore, in comparison with a case such as that shown in FIG. 23 in which the amplification factor of the residual vibration signal Vout is constant regardless of the temperature γ of the ink, with which the discharge section D is filled, it is possible to restrict the degree of change in the amplitude of the detection signal Vd in accordance with changes in the temperature γ of the ink, to a small amount.

As a result of this, even in a case in which the temperature γ of the ink changes, it is possible to determine whether or not the amplitude of the detection signal Vd is suitable without changing the threshold values Vth2 and Vth3, which the threshold value signals SVth show, and therefore, it is possible to create an effective flag Flag that suitably represents the discharge state in the discharge section D.

Additionally, the temperature αL shows the minimum temperature at which the discharge state determination process can be executed, and the temperature αH shows the maximum temperature at which the discharge state determination process can be executed. In other words, a range from the temperature αL to the temperature αH is an example of a “predetermined temperature range” at which the discharge state determination process can be executed.

In addition, in the temperature range from the temperature αL to the temperature αH, which is shown in FIG. 24, among the three temperature ranges that are split by the temperatures α1 and temperature α2, an arbitrary temperature, which belongs to the “αL≦α<α1” or the “α1≦α<α2”, is an example of a “first temperature”, and an arbitrary temperature, which belongs to a higher temperature range than the temperature range that the first temperature belongs to, is an example of a “second temperature”.

In addition, in the present embodiment, the control section 6 splits the temperature range from the temperature αL to the temperature αH into three temperature ranges using the temperatures α1 and temperature α2, but this is merely an example. The control section 6 may split the temperature range from the temperature αL to the temperature αH into two temperature ranges, and indicate the amplification factor β for each split. On the contrary, the control section 6 may split the temperature range from the temperature αL to the temperature αH into multiple temperature ranges of four or more, and indicate the amplification factor β for each split. In a case in which the temperature range is split into multiple temperature ranges, since it is possible to set the amplification factor β meticulously depending on the temperature γ of the ink, it is even possible to preserve the amplitude of the detection signal Vd in a case in which the temperature γ of the ink changes.

Additionally, the relationship between the temperature α and the amplification factor β that is shown in FIG. 24 may be stored in the memory section 60 in advance.

### 5. Ink Used in Present Embodiment

Next, the ink that is used in the present embodiment will be described.

The ink jet printer 1 according to the present embodiment uses an ultraviolet ray curable ink (hereinafter, also referred to as an “ink composition”). Hereinafter, a suitable ultraviolet ray curable ink will be described. A characterizing feature of ultraviolet ray curable ink is that the viscosity at 20° C. and the average polymerizable unsaturated double bond equivalent are respectively in predetermined ranges.

### 5.1. Viscosity at 20° C. of Ultraviolet Ray Curable Ink

The viscosity at 20° C. of the abovementioned ultraviolet ray curable ink is 25 mPa·s or less, is preferably 15 to 25 mPa·s, and is more preferably 17 to 23 mPa. If the viscosity at 20° C. is the abovementioned upper limit or less, the discharge stability of the ink is excellent. In addition, if the viscosity at 20° C. is the abovementioned lower limit or more, the generation of hardening wrinkles is effectively suppressed.

The principle according to which hardening wrinkles are generated assumes the following points, but the scope of the invention is not limited by the following assumptions. It is assumed that hardening wrinkles are generated as a result of a coating film surface, which is cured first, becoming deformed, ink of a coating film inner section flowing irregularly in a period before being cured, or the like, when the coating film inner section is cured later than the coating film surface after the coating film surface is cured first, or the like. In addition, there is a tendency for the polymerization contractiveness (with respect to a volume of an ink, which has a predetermined mass, before curing, a difference between the volume of the corresponding ink and a volume of the corresponding ink after curing (a cured material)) to increase in accordance with curing in an ultraviolet ray curable ink, in which the viscosity is low, and therefore, it is assumed that the generation of hardening wrinkles is significant. In addition, there is a tendency for the hardening wrinkles to be generated in an ultraviolet ray curable ink, which, among (meth)acrylate functional groups that will be described later, contains a vinyl ether group-containing (meth)acrylate that is represented by General Formula (I), which will be mentioned later, and in particular, it is assumed that the generation of hardening wrinkles is significant in an ultraviolet ray curable ink, which contains a vinyl ether group-containing (meth) acrylic acid that is represented by General Formula (I), and in which the viscosity is low. Even in a case in which the ultraviolet ray curable ink that is used in the ink jet recording method of the present embodiment has the abovementioned features, it is possible to effectively suppress the generation of hardening wrinkles by setting the viscosity to the abovementioned ranges.

In this instance, an example of a design method of the ink for setting the viscosity of the ink to a desired range will be described.

A mixture viscosity of all of the polymerizable compounds that are included in the ink can be estimated from the viscosities of each polymerizable compound that is used, and the mass ratios with respect to the ink composition of each of the corresponding polymerizable compounds.

It is assumed that the ink includes N types of polymerizable compound of polymerizable compounds A, B, (omission) . . . , and N. The viscosity of the polymerizable compound A is set as VA, and the mass ratio of the polymerizable compound A with respect to a polymerizable compound total in the ink is set as MA. The viscosity of the polymerizable compound B is set as VB, and the mass ratio of the polymerizable compound B with respect to a polymerizable compound total in the ink is set as MB. In the same manner, the viscosity of the polymerizable compound N is set as VN, and the mass ratio of the polymerizable compound N with respect to a polymerizable compound total in the ink is set as MN. To summarize, an equation “MA+MB+ . . . (Omission) . . . +MN=1” is established. In addition, the mixture viscosity of all of the polymerizable compounds that are included in the ink is set as VX. In such a case, it is assumed that the following Equation (1) is satisfied.

MA×Log VA+MB×Log VB+ . . . (Omission) . . . +MN×Log VN=Log VX (1)

Additionally, in a case in which, for example, two types of polymerizable compounds are included in the ink, the mass ratios of the polymerizable compounds after MB are set to 0. The number of types of polymerizable compound can be set to an arbitrary number of 1 or more.

Next, an example of a sequence (Steps 1 to 7) for setting the ink viscosity to the desired range will be described.

Firstly, information of the viscosities at a predetermined temperature of each polymerizable compound that is used is acquired (Step 1). Examples of a method of acquisition include acquisition from a maker's catalogue or the like, and measuring the viscosities at a predetermined temperature of each polymerizable compound, or the like. Since there are cases in which viscosities differ even for the same polymerizable compound depending on the maker, the viscosities of the polymerizable compounds may adopt viscosity information from a manufacturer of the polymerizable compounds that are used.

Subsequently, a target viscosity is set to the VX, and a compositional ratio (a mass ratio) of each polymerizable compound is determined on the basis of the abovementioned Equation (1) so that the VX reaches the target viscosity (Step 2). The target viscosity is a viscosity of an ink composition that is ultimately desired, and for example, is set to a viscosity which is in a range of 15 to 25 mPa·s. The predetermined temperature is set to 20° C.

Subsequently, a composition of the polymerizable compounds (hereinafter, referred to as a “polymerizable composition”.) is prepared by mixing the polymerizable compounds in a practical sense, and the viscosity at the predetermined temperature is measured (Step 3).

Next, in a case in which the viscosity of the polymerizable composition is approximately close to the abovementioned target viscosity (in the present step 4, it is sufficient as long as the viscosity is “the target viscosity ±5 mPa·s”.), an ink composition that includes the corresponding polymerizable composition, and components other than polymerizable compounds such as a photopolmerization initiator and a pigment (hereinafter, referred to as “components other than the polymerizable compounds”), is prepared, and the viscosity of the corresponding ink composition is measured (Step 4). In the abovementioned Step 4, in a case in which there are components, which are components other than the polymerizable compounds, and which, for example, are mixed into the ink in a liquid pigment dispersion form in the manner of a pigment, since polymerizable compounds, which are included in the liquid pigment dispersion in advance, are also introduced into the ink composition, it is necessary to adjust the ink composition with mass ratios, in which the mass ratios of the polymerizable compounds that are introduced into the ink composition as a liquid pigment dispersion have been subtracted from the compositional ratios of each polymerizable compound, which are determined in Step 2.

Next, a difference between the measured viscosity of the abovementioned ink composition, and a measured viscosity of the abovementioned polymerizable composition is calculated, and set as VY (Step 5). In this case, it is normally “VY>0”. VY depends on content conditions such as the type and contained amounts of the components other than the polymerizable compounds, but in an example, which will be described later, VY=3 to 5 mPa·s.

Subsequently, “the target viscosity of Step 2—VY” is established as VX, and the compositional ratios of each polymerizable compound is determined again from the abovementioned Equation (1) so the VX becomes the established “the target viscosity of Step 2—VY” (Step 6).

Next, the ink composition is prepared by mixing each polymerizable compound with the compositional ratios determined in Step 6 and the components other than the polymerizable compounds, and the viscosity at the predetermined temperature is measured (Step 7). As long as the measured viscosity is the target viscosity, the ink composition that is prepared in Step 7 is obtained as an ink composition that has the target viscosity.

Meanwhile, in Step 3, in a case in which the measured viscosity of the prepared composition of the polymerizable compounds does not fall within the range of “the target viscosity ±5 mPa·s”, Step 3 is performed again after performing the following minor adjustments. Firstly, in a case in which the measured viscosity is too high, minor adjustments of decreasing the contained amounts of polymerizable compounds, in which the viscosity is higher than the target viscosity, as a stand-alone unit, and increasing the contained amounts of polymerizable compounds, in which the viscosity is lower than the target viscosity, as a stand-alone unit, are performed. Meanwhile, in a case in which the measured viscosity is too low, minor adjustments of decreasing the contained amounts of polymerizable compounds, in which the viscosity is lower than the target viscosity, as a stand-alone unit, and increasing the contained amounts of polymerizable compounds, in which the viscosity is higher than the target viscosity, as a stand-alone unit, are performed. In addition, in Step 7, in a case in which the measured viscosity of the prepared ink composition is not the target viscosity, Step 7 is performed again after performing the abovementioned minor adjustments.

### 5.2. Average Polymerizable Unsaturated Double Bond Equivalent

A characterizing feature of the abovementioned ultraviolet ray curable ink is that the average polymerizable unsaturated double bond equivalent thereof is in a range of 100 to 150, is preferably 110 to 150, and is more preferably 120 to 150. If the average polymerizable unsaturated double bond equivalent is the abovementioned lower limit or more, since the reaction calories that are generated as a result curing are restricted to a small amount, it is possible to suppress rises in temperature following continuous printing, and therefore, excellent preservation stability is achieved. In addition, if the average polymerizable unsaturated double bond equivalent is the abovementioned upper limit or less, excellent curability is achieved.

In this instance, in the present specification, the term “average polymerizable unsaturated double bond equivalent” can be interchanged with the term average equivalent of polymerizable unsaturated double bonds. Compounds that include the corresponding polymerizable unsaturated double bonds can be referred to as compounds that include a polymerizable functional group, which is provided a polymerizable unsaturated double bond, and not limited to the following, for example, examples include (meth)acrylate compounds, vinyl compounds, vinyl ether compounds, and allyl compounds. It is sufficient as long as the compound that include polymerizable unsaturated double bonds are compounds that include 1 or more polymerizable functional group, and in a case of including 2 or more polymerizable functional groups, the same polymerizable functional groups may be used, or different polymerizable functional groups may be used. In addition, it is possible to classify each of the abovementioned compounds using the structure thereof other than the polymerizable functional group, into polymerizable compounds having an aromatic ring skeleton, polymerizable compounds having a cyclic or linear aliphatic skeleton, polymerizable compounds having a heterocyclic skeleton and the like.

In the present specification, the average polymerizable unsaturated double bond equivalent of the ultraviolet ray curable ink can be determined in the following manner. Firstly, a polymerizable compound polymerizable unsaturated double bond equivalent is calculated for each polymerizable compound using the following Equation (2).

Polymerizable compound polymerizable unsaturated double bond equivalent=molecular weight of polymerizable compound/number of polymerizable unsaturated double bonds included in polymerizable compound molecule (2)

The molecular weight of a polymerizable compound and the number of polymerizable unsaturated double bonds in the abovementioned Equation (2) can adopt values from a maker's catalogue, or values calculated from chemical structural formulae.

Next, the average polymerizable unsaturated double bond equivalent of the ink is calculated using the following Equation (3).

Average polymerizable unsaturated double bond equivalent of ink=(polymerizable compound polymerizable unsaturated double bond equivalent of polymerizable compound A×contained amount of polymerizable compound A in ink+polymerizable compound polymerizable unsaturated double bond equivalent of polymerizable compound B×contained amount of polymerizable compound B in ink+ . . . +polymerizable compound polymerizable unsaturated double bond equivalent of polymerizable compound n×contained amount of polymerizable compound n in ink)/(contained amount of polymerizable compound A in ink+contained amount of polymerizable compound B in ink+ . . . +contained amount of polymerizable compound n in ink) (3)

The abovementioned Equation (3) is a formula in which it is assumed that the ink includes n types of polymerizable compound, and the corresponding “n” is set as an arbitrary integer of 1 or more. In the abovementioned Equation (3), the “contained amount” represents a mass % with respect to a total mass of the ink.

The smaller the average polymerizable unsaturated double bond equivalent of the ink is, the more polymerizable unsaturated double bonds the corresponding ink contains, and the more reaction calories are generated in accordance with polymerization of the corresponding ink. Meanwhile, the larger the average polymerizable unsaturated double bond equivalent of the ink is, the fewer polymerizable unsaturated double bonds the corresponding ink contains, and the fewer reaction calories are generated in accordance with polymerization of the corresponding ink.

Hereinafter, additives (components) that can be incorporated in the ultraviolet ray curable ink in the present embodiment will be described.

### 5.3. Polymerizable Compounds

It is possible to cure printed ink as a result of the polymerizable compounds that are included in the ink being polymerized during the irradiation of light independently, or using a photo polymerization initiator, which will be described later. As a polymerizable compound, it is possible to use various multifunctional, including monofunctional, bifunctional, or, trifunctional or more, monomers or oligomers that are well known from the related art. For example, examples of the abovementioned monomers include unsaturated carboxylic acids such as (meth) acrylic acid, itaconic acid, crotonic acid, isocrotonic acid, maleic acid, and salts, esters, urethanes, amides and anhydrides thereof, acrylonitriles, styrenes, various unsaturated polyesters, unsaturated polyether, unsaturated polyamides, and unsaturated urethanes. In addition, for example, examples of the abovementioned oligomers include oligomers that are formed from the abovementioned monomers such as a linear acrylic oligomer, an epoxy (meth)acrylate, an oxetane (meth)acrylate, a cyclic or linear aliphatic urethane (meth)acrylate, an aromatic urethane (meth)acrylate, and a polyester (meth) acrylate.

Among the abovementioned compounds, an ester of a (meth) acrylic acid, that is, a (meth) acrylic acid is preferable. Among (meth) acrylic acids, the combined use of a monofunctional (meth) acrylic acid, and a bifunctional or more (meth) acrylic acid is preferable, and the combined use of a monofunctional (meth)acrylate, and a bifunctional (meth)acrylate is more preferable.

Hereinafter, the polymerizable compound will be described in further detail focusing on such (meth)acrylates. Moreover, since a vinyl ether group-containing (meth)acrylate ester that is represented by General Formula (I) is preferably included as an example of the abovementioned monofunctional (meth)acrylate, firstly, the abovementioned vinyl ether group-containing (meth)acrylate ester will be described.

### 5.3.1. Vinyl Ether Group-Containing (Meth)Acrylate Ester

It is preferable that the ink includes a vinyl ether group-containing (meth)acrylate ester that is represented by General Formula (I).

CH2=CR1-COOR2-O—CH═CH—R3 (I)

(In the formula, R1 is a hydrogen atom or a methyl group, R2 is a bivalent organic residue with a carbon number of 2 to 20, and R3 is a hydrogen atom or a monovalent organic residue with a carbon number of 1 to 11.)

As a result of the ink containing the corresponding vinyl ether group-containing (meth)acrylate ester, it is possible to lower the viscosity of the ink, and it is possible to achieve excellent ink curability, and therefore, it is possible to effectively suppress the generation of hardening wrinkles. Moreover, in terms of making the curability of the ink favorable, it is preferable to use a compound that includes a vinyl ether group and a (meth)acrylate group together in one molecule rather than using a compound that includes a vinyl ether group and a compound that includes a (meth)acrylate group separately.

In the abovementioned General Formula (I), a linear, branched or cyclic, optionally substituted alkylene group with a carbon number of 2 to 20, an optionally substituted alkylene group with a carbon number of 2 to 20 that includes an oxygen atom from an ether bond or an ester bond in the structure thereof, or an optionally substituted bivalent aromatic group with a carbon number of 6 to 11 are suitable as the bivalent organic residue with a carbon number of 2 to that is represented by R2. Among these, an alkylene group with a carbon number of 2 to 6 such as an ethylene group, an n-propylene group, an isopropylene group, or a butylene group, and an alkylene group with a carbon number of 2 to 9 that includes an oxygen atom from an ether bond in the structure thereof such as an oxyethylene group, an oxy n-propylene group, an oxyisopropylene group, or an oxybutylene group are suitably used.

In the abovementioned General Formula (I), a linear, branched or cyclic, optionally substituted alkylene group with a carbon number of 1 to 10, or an optionally substituted aromatic group with a carbon number of 6 to 11 are suitable as the monovalent organic residue with a carbon number of 1 to 11 that is represented by R3. Among these, an alkylene group with a carbon number of 1 to 2, which is a methyl group or an ethyl group, and an aromatic group with a carbon number of 6 to 8 such as a phenyl group or a benzoyl group are suitably used.

In a case in which each of the abovementioned organic residues is optionally substituted, the substituents thereof can be divided into groups that include a carbon atom, and groups that do not include a carbon atom. Firstly, in a case in which the abovementioned substituent is a group that includes a carbon atom, the corresponding carbon atoms are counted in the carbon number of the organic residue. Groups that include a carbon atom are not limited to the following, but, for example, examples thereof include a carboxyl group and an alkoxy group. Next, groups that do not include a carbon atom are not limited to the following, but, for example, examples thereof include a hydroxyl group and a halo group.

The abovementioned vinyl ether group-containing (meth)acrylate ester is not limited to the following but, for example, examples thereof include (meth) acrylic acid 2-vinyloxyethyl, (meth) acrylic acid 3-vinyloxy propyl, (meth) acrylic acid 1-methyl-2-vinyloxyethyl, (meth) acrylic acid 2-vinyloxy propyl, (meth) acrylic acid 4-vinyloxybutyl, (meth) acrylic acid 1-methyl-3-vinyloxy propyl, (meth) acrylic acid 1-vinyloxy methyl propyl, (meth) acrylic acid 2-methyl-3-vinyloxy propyl, (meth) acrylic acid 1,1-dimethyl-2-vinyloxyethyl, (meth) acrylic acid 3-vinyloxybutyl, (meth) acrylic acid 1-methyl-2-vinyloxy propyl, (meth) acrylic acid 2-vinyloxybutyl, (meth) acrylic acid 4-vinyloxy cyclohexyl, (meth) acrylic acid 6-vinyloxy hexyl, (meth) acrylic acid 4-vinyloxy methyl cyclohexyl methyl, (meth) acrylic acid 3-vinyloxy methyl cyclohexyl methyl, (meth) acrylic acid 2-vinyloxy methyl cyclohexyl methyl, (meth) acrylic acid p-vinyloxy methyl phenyl methyl, (meth) acrylic acid m-vinyloxy methyl phenyl methyl, (meth) acrylic acid o-vinyloxy methyl phenyl methyl, (meth) acrylic acid 2-(vinyloxy ethoxy) ethyl, (meth) acrylic acid 2-(vinyloxy isopropoxy) ethyl, (meth) acrylic acid 2-(vinyloxy ethoxy) propyl, (meth) acrylic acid 2-(vinyloxy ethoxy) isopropyl, (meth) acrylic acid 2-(vinyloxy isopropoxy) propyl, (meth) acrylic acid 2-(vinyloxy isopropoxy) isopropyl, (meth) acrylic acid 2-(vinyloxy ethoxy ethoxy) ethyl, (meth) acrylic acid 2-(vinyloxy ethoxy isopropoxy) ethyl, (meth) acrylic acid 2-(vinyloxy isopropoxy ethoxy) ethyl, (meth) acrylic acid 2-(vinyloxy isopropoxy isopropoxy) ethyl, (meth) acrylic acid 2-(vinyloxy ethoxy ethoxy) propyl, (meth) acrylic acid 2-(vinyloxy ethoxy isopropoxy) propyl, (meth) acrylic acid 2-(vinyloxy isopropoxy ethoxy) propyl, (meth) acrylic acid 2-(vinyloxy isopropoxy isopropoxy) propyl, (meth) acrylic acid 2-(vinyloxy ethoxy ethoxy) isopropyl, (meth) acrylic acid 2-(vinyloxy ethoxy isopropoxy) isopropyl, (meth) acrylic acid 2-(vinyloxy isopropoxy ethoxy) isopropyl, (meth) acrylic acid 2-(vinyloxy isopropoxy isopropoxy) isopropyl, (meth) acrylic acid 2-(vinyloxy ethoxy ethoxy ethoxy) ethyl, (meth) acrylic acid 2-(vinyloxy ethoxy ethoxy ethoxy ethoxy) ethyl, (meth) acrylic acid 2-(isopropenoxy ethoxy) ethyl, (meth) acrylic acid 2-(isopropenoxy ethoxy ethoxy) ethyl, (meth) acrylic acid 2-(isopropenoxy ethoxy ethoxy ethoxy) ethyl, (meth) acrylic acid 2-(isopropenoxy ethoxy ethoxy ethoxy ethoxy) ethyl, (meth) acrylic acid polyethylene glycol monovinyl ether, and (meth) acrylic acid polypropylene glycol monomethyl ether.

Among these, (meth) acrylic acid 2-(vinyloxy ethoxy) ethyl, that is, at least one of acrylic acid 2-(vinyloxy ethoxy) ethyl and methacrylic acid 2-(vinyloxy ethoxy) ethyl, is preferable, and acrylic acid 2-(vinyloxy ethoxy) ethyl is more preferable in terms of being able to further lower the viscosity of the ink, and achieving a high flash point and excellent ink curability. In particular, since acrylic acid 2-(vinyloxy ethoxy) ethyl and methacrylic acid 2-(vinyloxy ethoxy) ethyl have simple structures, and low molecular weights, it is possible to significantly lower the viscosity of the ink. Examples of the (meth) acrylic acid 2-(vinyloxy ethoxy) ethyl include (meth) acrylic acid 2-(2-vinyloxy ethoxy) ethyl, and (meth) acrylic acid 2-(1-vinyloxy ethoxy) ethyl, and examples of the acrylic acid 2-(vinyloxy ethoxy) ethyl include acrylic acid 2-(2-vinyloxy ethoxy) ethyl, and acrylic acid 2-(1-vinyloxy ethoxy) ethyl. Additionally, the acrylic acid 2-(vinyloxy ethoxy) ethyl has superior curability to the methacrylic acid 2-(vinyloxy ethoxy) ethyl.

The vinyl ether group-containing (meth) acrylic acid ester may use a single type, or may use a combination of two or more types.

The manufacturing method of the vinyl ether group-containing (meth) acrylic acid ester is not limited to the following, but examples thereof include a method that esterizes a (meth) acrylic acid and a hydroxyl group-containing vinyl ether (a manufacturing method B), a method that esterizes a (meth) acrylic acid halide and a hydroxyl group-containing vinyl ether (a manufacturing method C), a method that esterizes a (meth) acrylic acid anhydride and a hydroxyl group-containing vinyl ether (a manufacturing method D), a method that transesterifies a (meth) acrylic acid and a hydroxyl group-containing vinyl ether (a manufacturing method E), a method that esterizes a (meth) acrylic acid and a halogen-containing vinyl ether (a manufacturing method F), a method that esterizes a (meth) acrylic acid alkaline (earth) metal salt and a halogen-containing vinyl ether (a manufacturing method G), a method that performs a vinyl exchange reaction between a hydroxyl group-containing (meth) acrylic acid ester and a vinyl carboxylic acid (a manufacturing method H), and a method that performs an ether exchange reaction between a hydroxyl group-containing (meth) acrylic acid ester and an alkyl vinyl ether (a manufacturing method I).

Among these, the manufacturing method E is preferable since it is possible to further exhibit a desired effect of the present embodiment.

### 5.3.2. Monofunctional (Meth)Acrylate

It is preferable that the ink includes a monofunctional (meth)acrylate. In this instance, in a case in which the ink includes (on the condition of being limited to a monofunctional (meth)acrylate) the abovementioned vinyl ether group-containing (meth) acrylic acid ester, the vinyl ether group-containing (meth) acrylic acid ester is set as a compound that also includes the abovementioned monofunctional (meth)acrylate, but description of the corresponding vinyl ether group-containing (meth) acrylic acid ester will be omitted. Hereinafter, monofunctional (meth)acrylates other than the abovementioned vinyl ether group-containing (meth) acrylic acid esters will be described. As a result of the ink including the corresponding monofunctional (meth)acrylate, it is possible to lower the viscosity of the ink, and therefore, more superior ink curability, and excellent solubility of a photopolymerization initiator and other additives is achieved. Moreover, as a result of achieving excellent solubility of a photopolymerization initiator and other achieved, and, in addition, the toughness, heat resistance and chemical resistance of a coating film are increased.

For example, examples of the monofunctional (meth)acrylate include phenoxyethyl (meth)acrylate, isoamyl (meth) acrylate, stearyl (meth) acrylate, lauryl (meth)acrylate, octyl (meth)acrylate, decyl (meth)acrylate, isomyristyl (meth)acrylate, isostearyl (meth)acrylate, 2-ethylhexyl-diglycol (meth) acrylate, 2-hydroxybutyl (meth) acrylate, 4-hydroxybutyl (meth)acrylate, 2-methoxyethyl (meth)acrylate, butoxyethyl (meth)acrylate, ethoxy diethylene glycol (meth)acrylate, methoxy diethylene glycol (meth)acrylate, methoxy polyethylene glycol (meth)acrylate, methoxy propylene glycol (meth)acrylate, tetrahydrofurfuryl (meth)acrylate, isobornyl (meth)acrylate, 2-hydroxyethyl (meth) acrylate, 2-hydroxypropyl (meth)acrylate, 2-hydroxy-3-phenoxypropyl (meth)acrylate, lactone-modified flexible (meth)acrylate, t-butyl cyclohexyl (meth) acrylate, dicyclopentanyl (meth) acrylate, dicyclopentenyl oxyethyl (meth)acrylate, benzyl (meth)acrylate, ethoxylated nonyl phenyl (meth)acrylate, alkoxylated nonyl phenyl (meth)acrylate, and p-cumyl phenol EO-modified (meth) acrylate.

Among these, a monofunctional (meth)acrylate that has an aromatic skeleton in the molecule thereof is preferable since the curability, preservation stability, and solubility of the photopolymerization initiator are more superior. A monofunctional (meth)acrylate that has an aromatic skeleton in the molecule thereof is not limited to the following, but, for example, examples thereof include phenoxyethyl (meth)acrylate, benzyl (meth)acrylate, 2-hydroxy phenoxypropyl (meth)acrylate, and phenoxyethyl glycol (meth)acrylate. Among these, at least one of phenoxyethyl (meth)acrylate and benzyl (meth)acrylate is preferable, and phenoxyethyl (meth)acrylate is more preferable in terms of being able to lower the viscosity of the ink, and being able to achieve excellent curability, scratch resistance, adhesiveness of the ink with a target recording medium, and solubility of the photopolymerization initiator.

The monofunctional (meth)acrylate other than the vinyl ether group-containing (meth) acrylic acid ester may use a single type, or may use a combination of two or more types.

The contained amount of the monofunctional (meth)acrylate is preferably 30 to 70 mass % with respect to the total mass of the ink (100 mass %), and more preferably 40 to 60 mass %. If the corresponding contained amount is in the abovementioned ranges, it is easy to set the ink viscosity, or more specifically, both the ink viscosity at 20° C. and ink viscosity at an ink temperature (a discharge temperature) to a desired range. In addition, if the corresponding contained amount is the abovementioned lower limit or more, more superior curability, and excellent solubility of the photopolymerization initiator is achieved. Meanwhile, if the corresponding contained amount is the abovementioned upper limit or less, more superior curability, and excellent adhesiveness is achieved.

Additionally, in a case in which the ink includes the abovementioned vinyl ether group-containing (meth) acrylic acid ester, which is a monofunctional (meth)acrylate, the contained amount of the corresponding monofunctional (meth)acrylate includes the vinyl ether group-containing (meth) acrylic acid ester.

In particular, in a case in which the ink includes the abovementioned vinyl ether group-containing (meth) acrylic acid ester, the contained amount of the corresponding vinyl ether group-containing (meth) acrylic acid ester is preferably 10 to 50 mass % with respect to the total mass of the ink (100 mass %), and more preferably 15 to mass %. If the corresponding contained amount is the abovementioned lower limit or more, it is possible to lower the viscosity, and it is possible to achieve more superior curability of the ink. Meanwhile, if the corresponding contained amount is the abovementioned upper limit or less, it is possible to retain the preservation stability of the ink at a favorable state, and it is possible to further effectively suppress the generation of hardening wrinkles.

In addition, in a case in which the ink includes the abovementioned monofunctional (meth)acrylate other than the vinyl ether group-containing (meth) acrylic acid ester, the contained amount of the corresponding (meth)acrylate is preferably 10 to 40 mass %, and more preferably 10 to 30 mass %. If the corresponding contained amount is the abovementioned lower limit or more, in addition to superior curability, more superior solubility of the photopolymerization initiator is also achieved. Meanwhile, if the corresponding contained amount is the abovementioned upper limit or less, in addition to superior curability, more superior adhesiveness is achieved. A monofunctional (meth)acrylate that includes an aromatic ring skeleton is preferable as the abovementioned monofunctional (meth)acrylate other than the vinyl ether group-containing (meth) acrylic acid ester in terms of achieving more superior curability and solubility of the photopolymerization initiator.

### 5.3.3. Bifunctional or More (Meth)Acrylate

It is preferable that the ink includes a bifunctional or more (meth)acrylate. In the abovementioned manner, the combined use of a monofunctional (meth)acrylate and a bifunctional or more (meth)acrylate is preferable.

For example, examples of a bifunctional (meth)acrylate include diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-EO (ethylene oxide) adduct di(meth)acrylate, bisphenol A-PO (propylene oxide) adduct di(meth)acrylate, hydroxypivalic acid neopentyl glycol di(meth)acrylate, and polytetramethylene glycol di(meth)acrylate.

For example, examples of a trifunctional or more (meth)acrylate include trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerol propoxy tri(meth)acrylate, caprolactone-modified trimethylolpropane tri(meth)acrylate, pentaerythritol ethoxy tetra(meth)acrylate, and caprolactam-modified dipentaerythritol hexa (meth) acrylate.

The bifunctional or more (meth) acrylate may use a single type, or may use a combination of two or more types.

The contained amount of the bifunctional or more (meth) acrylate is preferably determined using a relationship with the preferable contained amount of the abovementioned monofunctional (meth) acrylate. The contained amount of the bifunctional or more (meth) acrylate is preferably 20 to 60 mass % with respect to the total mass of the ink (100 mass %), and more preferably 20 to 50 mass %. If the corresponding contained amount is in the abovementioned ranges, the curability of the ink and the scratch resistance of a cured product are excellent, and therefore, it is easy to design the viscosity of the ink to have a desired viscosity. In addition, it is preferable to combine a vinyl ether group-containing (meth) acrylic acid ester with a particularly low viscosity from among monofunctional (meth) acrylates, in which the viscosity of a simple substance of a polymerizable compound is comparatively low, and a different polymerizable compound with a comparatively high viscosity. As a result of this, it is easy to design the viscosity of the abovementioned ink to have a desired viscosity.

In addition, judging from a relationship with the preferable contained amount of the abovementioned monofunctional (meth) acrylate, it is preferable to include 30 to 70 mass % of the monofunctional (meth) acrylate, and 20 to 60 mass % of a bifunctional or more (meth) acrylate.

Additionally, it is suitable if the total contained amount of polymerizable compounds is approximately 50 to 95 mass % with respect to the total mass (100 mass %) of the ink depending on the relationship with the contained amounts of other components.

In addition, it is possible to omit the addition of a photopolymerization initiator by using a photopolymerizable compound as a polymerizable compound, but the use of a photopolymerization initiator is suitable since it is possible to easily adjust the initiation of polymerization.

### 5.4. Photopolymerization Initiator

In the present embodiment, the ink may include a photopolymerization initiator. The corresponding photopolymerization initiator is used in order to form prints by curing ink that is present on a surface of the recording sheets P as a result photopolymerization using the irradiation of ultraviolet rays. By using ultraviolet rays (UV) from among light, stability is excellent, and it is possible to restrict the costs of light source lamps. As long as the photopolymerization initiator initiates polymerization of the abovementioned polymerizable compounds as a result of forming activated species such as radicals and cations due to the energy of ultraviolet rays, the photopolymerization initiator is not limited, it is possible to use a photo-radical polymerization initiator or a photo-cationic polymerization initiator, but among these, the use of a photo-radical polymerization initiator is preferable.

For example, examples of the abovementioned photo-radical polymerization initiator include aromatic ketones, acylphosphine oxide compounds, aromatic onium salt compounds, organic peroxides, thio compounds (thioxanthone compounds, thiophenyl group-containing compounds and the like), hexaarylbiimidazole compounds, ketoxime ester compounds, borate compounds, azinium compounds, metallocene compounds, active ester compounds, compounds having a carbon-halogen bond, and alkylamine compounds.

Among these, acylphosphine oxide compounds are particularly preferable in terms of being able to make the curability of the ink more favorable.

More specific examples of photo-radical polymerization initiators include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophenone, 4-chloro-benzophenone, 4,4′-dimethoxy benzophenone, 4,4-diamino benzophenone, Michler's ketone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenyl-propan-1-one, thioxanthone, diethyl thioxanthone, 2-isopropyl thioxanthone, 2-chloro thioxanthone, 2-methyl-1-[4-(methylthio)phenyl]-2-morpholino-propan-1-one, bis(2,4,6-trimethylbenzoyl)-phenyl phosphine oxide, 2,4,6-trimethylbenzoyl-diphenyl-phosphine oxide, 2,4-diethyl thioxanthone, and bis-(2,6-dimethoxybenzoyl)-2,4,4-trimethylpentyl phosphine oxide.

For example, examples of commercial photo-radical polymerization initiator products include IRGACURE 651 (2,2-dimethoxy-1,2-diphenylethane-1-one), IRGACURE 184 (1-hydroxy-cyclohexyl-phenyl-ketone), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propan-1-one), IRGACURE 127 (2-hydroxy-1-{4-[4-(2-hydroxy-2-methyl-propionyl)-benzyl] phenyl]-2-methyl-propan-1-one}, IRGACURE 907 (2-methyl-1-(4-methylthiophenyl)-2-morpholino-1-one), IRGACURE 369 (2-benzyl-2-dimethylamino-1-(4-morpholinophenyl)-butanone-1), IRGACURE 379 (2-(dimethylamino)-2-[(4-methylphenyl) methyl]-1-[4-(4-morpholinyl) phenyl]-1-butanone), DAROCUR TPO (2,4,6-trimethyl benzoyl-diphenyl-phosphine oxide), IRGACURE 819 (bis(2,4,6-trimethylbenzoyl)-phenyl phosphine oxide), IRGACURE 784 (bis(η5-2,4-cyclopentadiene-1-yl)-bis(2,6-difluoro-3-(1H-pyrrol-1-yl)-phenyl) titanium), IRGACURE OXE 01 (1.2-octanedione, 1-[4-(phenylthio)-, 2-(O-benzoyl oxime)]), IRGACURE OXE 02 (ethanone, 1-[9-ethyl-6-(2-methylbenzoyl)-9H-carbazol-3-yl]-, 1-(O-acetyl oxime)), IRGACURE 754 (mixture of oxy-phenyl acetic acid, 2-[2-oxo-2-phenyl acetoxyethoxy] ethyl ester and oxy-phenyl acetic acid, 2-(2-hydroxyethoxy) ethyl ester) (all product names manufactured by BASF SE), KAYACURE DETX-S (2,4-diethylthioxanthone) (product name manufactured by Nippon Kayaku Co., Ltd.), Speedcure TPO (2,4,6-trimethyl benzoyl-diphenyl-phosphine oxide), Speedcure DETX (2,4-diethylthioxanthene-9-one) (all product names manufactured by Lambson Limited), Lucirin TPO, LR8893 and LR8970 (all product names manufactured by BASF SE), and Ubecryl P36 (product name manufactured by UCB Co. Ltd.) and the like.

The photopolymerization initiator may use a single type, or may use a combination of two or more types.

The contained amount of the photopolymerization initiator is preferably 20 mass % or less with respect to the total mass of the ink (100 mass %) in terms of being able to achieve excellent curability by improving a ultraviolet rays curing velocity, and avoiding a melted residue of the photopolymerization initiator and coloring that derives from the photopolymerization initiator.

In particular, in a case in which the photopolymerization initiator includes an acylphosphine oxide compound, the contained amount thereof is preferably 5 to 15 mass % with respect to the total mass of the ink (100 mass %), and is more preferably 7 to 13 mass %. If the contained amount is the abovementioned lower limit or more, more superior curability is achieved. More specifically, more superior curability is achieved since a sufficient curing velocity is obtained when curing with an LED (preferable emission peak wavelength: 360 nm to 420 nm) in particular. Meanwhile, if the contained amount is the abovementioned upper limit or less, more superior solubility of the photopolymerization initiator is achieved.

### 5.5. Color Material

In the present embodiment, the ink may include a color material. As a color material, it is possible to use at least one of a pigment and a dye.

### 5.5.1. Pigment

By using a pigment as the color material, it is possible to improve the light stability of the ink. The pigment can use either an inorganic pigment or an organic pigment.

As an inorganic pigment, it is possible to use furnace black, lamp black, acetylene black, a carbon black such as channel black (C.I. Pigment Black 7), iron oxide, or titanium oxide.

Examples of an organic pigment include insoluble azo pigments, condensed azo pigments, azo lake, azo pigments such as chelate azo pigments, phthalocyanine pigments, perylene and perinone pigments, anthraquinone pigments, quinacridone pigments, dioxane pigments, thioindigo pigments, isoindolinone pigments, polycyclic pigments such as quinophthalone pigments, dye chelates (for example, basic dye chelates, acidic dye chelates, or the like), color lakes (basic dye lakes and acidic dye lakes), nitro pigments, nitroso pigments, aniline black, and daylight fluorescent pigments.

Examples of pigments that can be used in white ink include C.I. pigments White 6, 18, and 21.

Examples of pigments that can be used in yellow ink include C.I. pigments Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of pigments that can be used in magenta ink include C.I. pigments Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57: 1, 88, 112, 114, 122, 123, 144, 146, 149, 150, 166, 168, 170, 171, 175, 176, 177, 178, 179, 184, 185, 187, 202, 209, 219, 224, and 245, and C.I. pigments Violet 19, 23, 32, 33, 36, 38, 43, and 50.

Examples of pigments that can be used in cyan ink include C.I. pigments blue 1, 2, 3, 15, 15:1, 15:2, 15:3, 15:34, 15:4, 16, 18, 22, 25, 60, 65, and 66, and C.I. vat blue 4, and 60.

In addition, for example, examples of pigments other than magenta, cyan and yellow include C.I. pigments Green 7, and 10, C.I. pigments Brown 3, 5, 25, and 26, and C.I. pigments Orange 1, 2, 5, 7, 13, 14, 15, 16, 24, 34, 36, 38, 40, 43, and 63.

The pigment may use a single type, or may use a combination of two or more types.

In a case in which the abovementioned pigment is used, the average particle diameter thereof is preferably 300 nm or less, and is more preferably 50 to 200 nm. If the average particle diameter is in the abovementioned ranges, excellent reliability such as discharge stability and dispersal stability, is achieved, and it is possible to form an image with excellent image quality. In this instance, in the present specification, the average particle diameter is measured using a dynamic light scattering technique.

### 5.5.2. Dye

It is possible to use a dye as a color material. The dye is not particularly limited, and it is possible to use an acid dye, a direct dyes, a reactive dyes, and a basic dyes. For example, examples of a dye include C.C.I. acid yellow 17, 23, 42, 44, 79, and 142, C.I. acid red 52, 80, 82, 249, 254, and 289, C.I. acid blue 9, 45, and 249, C.I. acid black 1, 2, 24, and 94, C.I. food black 1, and 2, C.I. direct yellow 1, 12, 24, 33, 50, 55, 58, 86, 132, 142, 144, and 173, C.I. direct red 1, 4, 9, 80, 81, 225, and 227, C.I. direct blue 1, 2, 15, 71, 86, 87, 98, 165, 199, and 202, C.I. direct black 19, 38, 51, 71, 154, 168, 171, and 195, C.I. reactive red 14, 32, 55, 79, and 249, C.I. reactive Black 3, 4, and 35.

The dye may use a single type, or may use a combination of two or more types.

The contained amount of the dye is preferably 1 to 20 mass % with respect to the total mass % of the ink (100 mass %) in terms of excellent concealment and color reproducibility being obtained.

### 5.6. Dispersant

In the present embodiment, in a case in which the ink includes a pigment, a dispersant may be included in order to set the dispersibility of the pigment to be more favorable. The dispersant is not particularly limited, but for example, examples thereof include a dispersant that is commonly used in order to prepare a liquid pigment dispersion such as a polymeric dispersant. Specific examples thereof include polyoxyalkylenes, polyalkylenes, polyamines, vinyl polymers and copolymers, acrylic polymers and copolymers, polyesters, polyamides, polyimides, polyurethanes, amino-based polymer, silicon-containing polymers, sulfur-containing polymers, fluorinated polymers, and compounds in which one or more of the epoxy resins is the main component. For example, examples of commercial polymeric dispersant products include the AJISPER series (trade name) manufactured by Ajinomoto Fine-Techno Co., Ltd., the Solsperse series available from Avecia Co. (Solsperse 32000, 36000, and the like [trade names]), the Disperbyk series (trade name) manufactured by BYKChemie Co., and the Disparlon series (trade name) manufactured by Kusumoto Chemicals, Ltd.

The dispersant may use a single type, or may use a combination of two or more types. Additionally, the contained amount of the dispersant is not particularly limited, and a preferable amount may be added as appropriate.

### 5.7. Other Additives

In the present embodiment, the ink may include additives (components) other that the additives included as examples above. Such a component is not particularly limited, but, for example, a fluorescent whitening agent (a sensitizer), a surfactant such as a silicone-based surfactant, a polymerization inhibitor, a polymerization accelerator, a penetration enhancer, a wetting agents (a humectant), and other additives, which is well-known from the related art can be used. For example, examples of the abovementioned other additive include adhesion promoters, mildew-proofing agents, antiseptic agents, antioxidants, ultraviolet absorbers, chelating agents, pH adjusting agents, and thickeners which are well-known from the related art.

Next, the recording sheets P that are used in the ink jet printer 1 and each step that is included in a recording method according to the present embodiment will be described in further detail.

### 5.8. Target Recording Medium

For example, examples of the abovementioned recording sheets P include non-ink-absorbing or low absorption target recording media. Among the corresponding target recording media, for example, examples of a non-ink-absorbing recording medium include recording media in which plastic is coated onto, or in which a plastic film is bonded to a base material such as a plastic film, paper or the like which has not been surface treated for ink jet recording (that is, on which an ink absorption layer has not been formed). Examples of a plastic film that is referred to in this instance include Polyvinyl chloride (PVC), polyethylene terephthalate (PET), polycarbonate (PC), polystyrene (PS), polyurethane (PU), polyethylene (PE), polypropylene (PP), and the like. Examples of a low absorption target recording medium include printing paper such as art paper, coated paper, matte paper, and the like.

### 5.9. Discharge Step

The discharge step in the present embodiment is a step in which the ultraviolet ray curable ink is discharged from the discharge sections D toward the recording sheets P in the printing process and the discharge state determination process after setting the ultraviolet ray curable ink to a suitable temperature. Further, the suitable temperature in the corresponding printing process is 30 to 40° C.

The abovementioned temperature range of 30 to 40° C. is a comparatively low temperature as a temperature that is achieved by heating. In this manner, when the temperature of the ink to be discharged is a comparatively low temperature, an advantageous effect of the discharge stability of ink being favorable due to the fact that there is little variation in the temperature, is obtained.

Hereinafter, the abovementioned discharge temperature will be described more specifically. When the corresponding discharge temperature is 30° C. or more, excellent discharge stability is achieved. In addition to this, the viscosity of ultraviolet ray curable ink that can be discharged at less than 30° C. is extremely low, but a problem in that it is easy for hardening wrinkles to be generated as a result of the low viscosity, arises. In contrast to this, the ink in the present embodiment can avoid the corresponding problem. Additionally, in a case in which the technique of the printer is a line printer technique, and a light source is a light-emitting diode (LED), the abovementioned problem is particularly significant. Therefore, the problem has a particularly large effect in a case in which a line printer and an LED is used in the present embodiment.

Meanwhile, when the corresponding discharge temperature is 40° C. or less, it is possible to suppress temperature rises inside the ink jet printer 1.

In addition, a temperature range, which is a range of the abovementioned discharge temperature is preferably 34 to 40° C. in terms of further increasing the abovementioned effects, and reliably avoiding the abovementioned problem.

In addition, the viscosity of the ink in the abovementioned temperature range is preferably 8 to 15 mPa·s, and more preferably 8 to 13 MPa·s. When the corresponding viscosity is in the abovementioned ranges, it is possible to effectively suppress the generation of hardening wrinkles due to the composition of the ink, and the instability of discharge due to high viscosity is prevented, and therefore, more superior discharge stability is achieved.

In addition, since, in the abovementioned manner, the viscosity of ultraviolet ray curable ink is higher than that of an aqueous ink that is normally used in an ink jet printer ink, there are large fluctuations in viscosity due to fluctuations in temperature during discharge. Such fluctuations in the viscosity of the ink have a large influence on changes in ink droplet size, and changes in liquid droplet discharge velocity, and furthermore, can give rise to deteriorations in image quality. Therefore, it is preferable that the temperature of the ink that is discharged (the discharge temperature) is kept constant as much as possible. As a result of the discharge temperature of the ink in the present embodiment being a comparatively low temperature, and temperature regulation by heating, it is possible to keep the discharge temperature substantially constant. Accordingly, excellent image stability is achieved in the present embodiment.

### 5.10. Curing Step

A curing step that is included in the recording method of the present embodiment cures by irradiating ultraviolet ray curable ink that is adhered to the recording sheets P with ultraviolet rays (light) from a light source. In the present step, a photopolymerization initiator, which is included in the ink is broken down as a result of the irradiation of ultraviolet rays, initiator species such as radicals, acids, bases, and the like are generated, and a polymerization reaction of polymerizable compounds is promoted by the functions of the initiator species. Alternatively, in the present step, a polymerization reaction of polymerizable compounds is initiated by irradiation with ultraviolet rays. At this time, if a sensitizing dye is present in the ink along with a photopolymerization initiator, it is possible to achieve a more sensitive curing reaction due to the sensitizing dye in the system entering an excited state as a result absorbing the ultraviolet rays, and promoting breakdown of the photopolymerization initiator by coming into contact with the photopolymerization initiator.

As a light source a mercury lamp, a gas or solid state lasers and the like are mainly used, and as a light source that is used in the curing of the ultraviolet ray curable ink, a mercury lamp, and a metal halide lamp are widely known. Meanwhile, a mercury-free lamp is strongly desirable from viewpoint of current environmental protection, and substitution with GaN-based ultraviolet emitter is useful both industrially and environmentally. Furthermore, LEDs (light-emitting diodes) such as ultraviolet emitting diodes (UV-LEDs) and ultraviolet ray laser diodes (UV-LDs) are compact, long-life, high efficiency and low cost, and therefore, use as light sources for ultraviolet ray curable ink is expected.

In this manner, a light source of the ultraviolet ray curable ink in the present embodiment can suitably use either an LED or a metal halide lamp, but among these, an LED is preferable.

The emission peak wavelength of the abovementioned light source is preferably 360 to 420 nm, and more preferably 380 to 410 nm. It is suitable if the emission peak wavelength is in the abovementioned ranges, since the acquisition of UV-LEDs is easy, and the price is inexpensive.

In addition, the ultraviolet ray peak intensity (the irradiation peak intensity) of the ultraviolet rays that are irradiated from a light source (preferably an LED) that has the abovementioned emission peak wavelength is preferably 500 mW/² or more, more preferably 800 mW/cm² or more, and still more preferably 1000 mW/cm² or more. If the irradiation peak intensity is in the abovementioned ranges, more superior curability is achieved, and it is possible to further effectively suppress the generation of hardening wrinkles. In particular, by setting the irradiation peak intensity of the ultraviolet rays, which ink that is discharged onto the recording sheets P are initially irradiated with, to the abovementioned ranges, it is possible to further effectively suppress the generation of hardening wrinkles. The principle according to which hardening wrinkles are generated assumes the abovementioned points, if the irradiation peak intensity is set within the abovementioned ranges, it is possible to cure an inner section at the same time as curing the coating film surface, and therefore, it is assumed that it is possible to effectively suppress the generation of hardening wrinkles. Furthermore, if the viscosity at 20° C. of the ink in the present embodiment is 15 mPa·s or more, it is possible to further effectively suppress the generation of hardening wrinkles. In particular, if the ultraviolet ray curable ink contains the abovementioned vinyl ether group-containing (meth) acrylic acid ester that is represented by General Formula (I), and the irradiation peak intensity is set within the abovementioned ranges, more superior curability is achieved, and it is possible to still further effectively suppress the generation of hardening wrinkles.

Additionally, the irradiation peak intensity in the present specification adopts value that were measured using an ultraviolet ray intensity meter UM-10 and a receptor UM-400 (both manufactured by Konica Minolta, Inc.). However, this is not intended to limit a measurement method of the irradiation peak intensity, and it is possible to use a measurement method that is well-known from the related art.

It is preferable that the ultraviolet ray curable ink in the present embodiment can cure by irradiating with an irradiation energy of 200 mJ/cm² or less. By using the corresponding ultraviolet ray curable ink in the recording method of the present embodiment, curing using an LED in which the irradiation energy is comparatively small is made possible, and therefore, it is possible to reduce the generation of heat in the LED, and it is possible to realize a high printing velocity with low-cost printing. A lower limit of irradiation energy by which the ink is curable is not particularly limited, but 100 mJ/cm² or more is suitable.

In addition, the irradiation energy while performing recording is preferably 600 mJ/cm² or less, and more preferably 500 mJ/cm² or less in terms of suppressing the generation of heat in accordance with irradiation. A lower limit of the irradiation energy while performing recording is not particularly limited, but 200 mJ/cm² or more is suitable in terms of sufficiently performing curing. In this instance, in a case in which irradiation is performed a plurality of times, the abovementioned irradiation energy while performing recording is a total irradiation energy in which each irradiation energy has been summed.

Additionally, the irradiation energy in the present specification is calculated by multiplying the irradiation peak intensity by a period from the initiation of irradiation to the completion of irradiation. In addition, in a case in which irradiation is performed across a plurality of times, the abovementioned irradiation energy is represented by an irradiation energy amount in which the irradiation of the plurality of times has been summed. The emission peak wavelength may be a single wavelength within the abovementioned it is preferable that ranges, or may be a plurality thereof. Even in a case in which there are a plurality of emission peak wavelengths, a total irradiation energy amount of the ultraviolet rays, which have emission peak wavelengths in the abovementioned ranges are set as the abovementioned irradiation energy.

This kind of ink is obtained by including a photopolymerization initiator, which breaks down as a result of irradiation with ultraviolet rays in the abovementioned wavelength range, and at least one polymerizable compound in which polymerization is initiated as a result of irradiation with ultraviolet rays in the abovementioned wavelength range.

In addition, a discharge amount (an attachment amount or an impacting amount) of the ink per unit area of the recording sheets P during discharge is preferably 5 to 16 mg/inch² in terms of preventing the wasteful use of the ink.

In addition, the discharge amount of the ink per unit area changes depending on a recording resolution, and an ink amount that is impacted per recording unit region (pixel) that is defined by the recording resolution, but if the recording resolution (a printing resolution) represents “a resolution in a sub-scanning direction×a resolution in a direction (a main scanning direction) that intersects the sub-scanning direction”, is preferably 300 dpi×300 dpi to 1500 dpi×1500 dpi. Further, it is preferable to adjust the nozzle density and the discharge amount of the recording head 3 depending on the recording resolution.

Additionally, the discharge among of the ink per pixel is preferably 2 to 50 ng/pixel, and more preferably 3 to 20 ng/pixel. In addition, the nozzle density (the distance between nozzles in the nozzle rows) is preferably 180 to 720 dpi, and more preferably 300 to 720 dpi.

In this manner, according to the present embodiment, excellent curability, discharge stability, and suppression of temperature rises inside the ink jet printer 1 after continuous printing are all achieved, and therefore, it is possible to provide an ink jet recording method that is capable of further suppressing the generation of hardening wrinkles. Moreover, even in a case in which a ultraviolet ray curable ink with low viscosity is used, the recording method of the present embodiment has excellent suppression of temperature rises inside a recording apparatus after continuous printing while securing excellent curability and discharge stability.

### 6. Conclusion of Embodiment

In the manner described above, in present embodiment, the amplification factor β, which the amplification factor indication signal AM indicates, is determined on the basis of the temperature α, which the temperature information KT that the temperature sensor 8 outputs, shows, and the detection signal Vd is created by amplifying the residual vibration signal Vout by the corresponding amplification factor β. Therefore, even in a case in which the temperature γ of the ink changes, the degree of change in the amplitude of the detection signal Vd is restricted to a small amount, and therefore, it is possible to create an effective flag Flag that accurately represents the discharge state of the ink in the discharge sections D.

### B. MODIFICATION EXAMPLES

Each of the abovementioned embodiments can be modified in a variety of ways. Aspects of specific modifications are illustrated by way of example below. Two or more aspects chosen arbitrarily from the following examples can be combined as appropriate within a range in which the aspects do not contradict one another.

Additionally, in the Modification Examples that are illustrated by way of example below, the reference symbols that referred to in the abovementioned description are reused for features for which the actions or functions thereof are equivalent to those of the embodiment, and the respective detailed descriptions thereof are omitted as appropriate.

### Modification Example 1

In the abovementioned embodiment, the degree of change in the amplitude of the detection signal Vd, which is set to a small amount by changing the amplification factor β of the residual vibration signal Vout depending on changes in the amplification factor β of the ink, and as a result, an effective flag Flag that accurately represents the discharge state in the discharge sections D is created, but the invention is not limited to such an aspect, and even if the amplitude of the detection signal Vd changes in accordance with changes in the temperature γ of the ink, an effective flag Flag that accurately represents the discharge state in the discharge sections D may be created by changing the threshold value potential that the threshold value signals SVth show depending on changes in the temperature γ of the ink.

More specifically, the threshold values Vth2 and Vth3, which the threshold value signals SVth show, may be determined on the basis of the temperature α, which the temperature information KT that the temperature sensor 8 outputs, shows, and the effective flag Flag may be created by comparing the potential of the detection signal Vd with the threshold values Vth2 and Vth3.

FIG. 25 is a diagram that shows a relationship between the temperature α, which the temperature information KT that the temperature sensor 8 outputs, shows, and the threshold values Vth2 and Vth3, which the threshold value signals SVth2 and SVth3 that the control section 6 of the present Modification Example outputs, show.

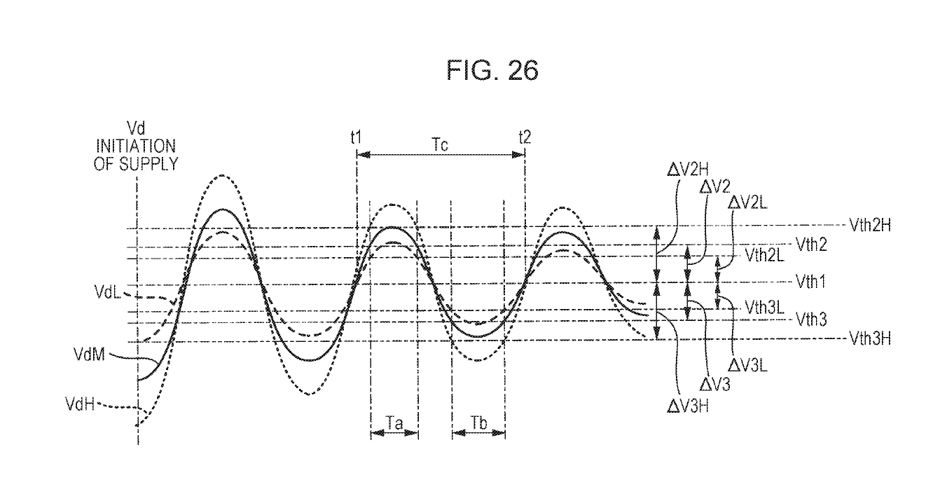

As shown in FIG. 25, the control section 6 outputs threshold value signals SVth that indicate “Vth2L” as the threshold value Vth2, and indicate “Vth3L” as the threshold value Vth3 in a case in which the temperature α satisfies “αL≦α<α1”, outputs threshold value signals SVth that indicate “Vth2” as the threshold value Vth2, and indicate “Vth3” as the threshold value Vth3 in a case in which the temperature α satisfies “α1≦α<α2”, and outputs threshold value signals SVth that indicate “Vth2H” as the threshold value Vth2, and indicate “Vth3H” as the threshold value Vth3 in a case in which the temperature α satisfies “α2≦α<αH”. In this instance, as shown in FIG. 26, the threshold values Vth2L, Vth2, and Vth2H, satisfy “Vth1<Vth2L<Vth2<Vth2H”, and threshold values Vth3L, Vth3, and Vth3H, satisfy “Vth1>Vth3L>Vth3>Vth3H”. That is, in the present Modification Example, the control section 6 creates threshold value signals SVth according to which the threshold value Vth2 increases in accordance with increases in the temperature α, and the threshold value Vth3 decreases in accordance with increases in the temperature α. In other words, the control section 6 creates threshold value signals SVth according to which the differences in potential ΔV2 and ΔV3 become larger in accordance with increases in the temperature α.

Therefore, as shown in FIG. 26, even in a case in which the amplitude of the detection signal Vd changes in accordance with changes in the temperature γ of the ink, it is possible to keep the period Ta and the period Tb substantially constant. As a result of this, even in a case in which the temperature γ of the ink changes, it is possible to determine whether or not the amplitude of the detection signal Vd is suitable without changing the amplification factor β of the residual vibration signal Vout, and therefore, it is possible to create an effective flag Flag that suitably represents the discharge state in the discharge sections D.

Additionally, the invention may create the effective flag Flag by combining the abovementioned embodiment and the present Modification Example. That is, the control section 6 may create an amplification factor indication signal AM according to which the amplification factor β decreases in accordance with increases in the temperature α, and create threshold value signals SVth according to which the differences in potential ΔV2 and ΔV3 become larger in accordance with increases in the temperature α.

### Modification Example 2

In the abovementioned embodiment and Modification Example, the discharge state determination process is executed in the unit determination period Tu-T, but the invention not limited to such an aspect, and the discharge state determination process may also be executed in the unit printing period Tu-P. That is, the printing process and the discharge state determination process may be executed in the same unit period Tu.

For example, in the unit printing period Tu-P that is shown in FIG. 16, the waveform PA1, which the printing driving waveform signal Com-AP includes, may also be made to take on a role of detecting the residual vibrations (a role as the waveform PT). In this case, the residual vibrations of the discharge sections D, which occur as a result of driving due to the waveform PA1 may be detected by setting a portion of the period in which the potential of the waveform PA1 is retained at the maximum potential Va12, to be the detection period Td.

In addition, the waveform for detecting the residual vibrations may be a waveform for discharging the ink in the manner of the waveform PA1 and the waveform PA2, or may be a waveform that does not discharge the ink in the manner of the waveform PB.

### Modification Example 3

The ink jet printer 1 according to the abovementioned embodiment and Modification Examples is provided with a single detection signal creation section 52, and a single discharge state determination section 4, and the discharge state determination process is executed in a single unit period Tu with a single discharge section D set as the target thereof, but the invention not limited to such an aspect, and a configuration that can execute a discharge state determination process in a single unit period Tu with two or more discharge sections D set as the targets thereof, may also be used.

For example, the ink jet printer 1 may have a configuration in which a plurality of detection signal creation sections 52 are installed, and which is capable of simultaneously detecting the residual vibration signals Vout from a plurality of discharge sections D in each unit period Tu. Further, in this case, the discharge state determination section 4 preferably has a configuration that can determine the discharge states of the ink in the plurality of discharge sections D on the basis of a plurality of detection signals Vd that the plurality of detection signal creation sections 52 output. For example, it is suitable if the discharge state determination section is equipped with a plurality of measurement sections 41 and a plurality of determination information creation sections 42 to correspond to the plurality of detection signal creation sections 52.

### Modification Example 4

The ink jet printer 1 according to the abovementioned embodiment and Modification Examples, is a line printer in which nozzle rows Ln are provided in a manner in which the range YNL includes the range YP, but the invention not limited to such an aspect, and the ink jet printer 1 may be a serial printer in which the recording head 3 executes a protruding part by reciprocating in a Y axis direction.

### Modification Example 5

The ink jet printer 1 according to the abovementioned embodiment and Modification Examples is capable of discharging the four colors of CMYK, but the invention not limited to such an aspect, and the ink jet printer 1 may be capable of discharging at least one or more color of ink, and in addition the colors of the ink may be colors other than CMYK.

In addition, the ink jet printer 1 according to the abovementioned embodiment and Modification Examples is provided with four rows of the nozzle rows Ln, but may be provided with at least one or more row of the nozzle row Ln. In addition, for example, in a case in which the ink jet printer 1 is provided with one row of a nozzle row Ln, the ink jet printer 1 may be equipped with at least one or more discharge section D (in other words, it is suitable is M is a nonnegative integer that satisfies M 1).

### Modification Example 6

In the abovementioned embodiment, and Modification Examples, the driving waveform signal Com includes the signals of two systems of the driving waveform signals Com-A and Com-B, but the invention not limited to such an aspect, and the driving waveform signal Com may include the signals of one or more systems. In other words, for example, the driving waveform signal Com may be a signal that includes the signals of a single system, for example, the driving waveform signal com-A only, or, may be a signal that includes the signals of three or more systems, for example, driving waveform signals Com-A, Com-B and Com-C.

In addition, in the In the abovementioned embodiment and Modification Examples, the unit period Tu includes the two control periods Ts1 and Ts2, but the invention not limited to such an aspect, and the unit period Tu may be formed from a single control period Ts, or may include three or more control periods Ts.

In addition, in the In the abovementioned embodiment and Modification Examples, the printing signal SI[m] is a two-bit signal, but the bit number of the printing signal Si[m] may be determined as appropriate depending on a gradation that should be disposed, the number of control period Is that are included in the unit period Tu, the number of systems of the signals that are included in the driving waveform signal Com, and the like.

### Modification Example 7

In the abovementioned embodiment, and Modification Examples, the head driver 5 is equipped with a single driving signal creation section 51, and a single type of driving waveform signal Com is supplied to the corresponding driving signal creation section 51, but the invention not limited to such an aspect, and for example, the head driver may be provided with a plurality of driving signal creation sections 51, which are provided for each ink color that the discharge sections D discharge, and the control section 6 may supply a plurality of types of driving waveform signal Com, which correspond to the plurality of driving signal creation sections 51 on a one-to-one basis, to the head driver 5.

What is claimed is:

1. A liquid discharging apparatus comprising:
a housing;
a head unit that is provided in the housing, and includes a discharge section, which is provided with a piezoelectric element that is displaced depending on a driving signal, a pressure chamber, the internal pressure of which is increased and decreased by displacement of the piezoelectric element, and a nozzle, which is in communication with the pressure chamber, and is capable of discharging a liquid, which the inside of the pressure chamber is filled with, depending on increases and decreases in the internal pressure of the pressure chamber;
a driving signal creation section that creates the driving signal;
a temperature information creation section that creates temperature information, which shows a temperature of a predetermined location inside the housing;
a detection signal creation section that creates a detection signal by amplifying a residual vibration signal, which shows residual vibrations that occur in the discharge section after the piezoelectric element is displaced depending on the driving signal, with an amplification factor that depends on a temperature, which the temperature information shows; and
a discharge state determination section that determines a discharge state of the liquid in the discharge section on the basis of the detection signal.

2. The liquid discharging apparatus according to claim 1,
wherein the amplification factor, which the detection signal creation section uses in the amplification of the residual vibration signal, in a case in which the temperature, which the temperature information shows, is a first temperature, which is included in a predetermined temperature range, is higher than the amplification factor, which the detection signal creation section uses in the amplification of the residual vibration signal, in a case in which the temperature, which the temperature information shows, is a second temperature, which is included in the predetermined temperature range, and is higher than the first temperature.

3. A liquid discharging apparatus comprising:
a housing;
a head unit that is provided in the housing, and includes a discharge section, which is provided with a piezoelectric element that is displaced depending on a driving signal, a pressure chamber, the internal pressure of which is increased and decreased by displacement of the piezoelectric element, and a nozzle, which is in communication with the pressure chamber, and is capable of discharging a liquid, which the inside of the pressure chamber is filled with, depending on increases and decreases in the internal pressure of the pressure chamber;
a driving signal creation section that creates the driving signal;
a temperature information creation section that creates temperature information, which shows a temperature of a predetermined location inside the housing;
a detection signal creation section that creates a detection signal by amplifying a residual vibration signal, which shows residual vibrations that occur in the discharge section after the piezoelectric element is displaced depending on the driving signal; and
a discharge state determination section that determines a discharge state of the liquid in the discharge section on the basis of the detection signal and a threshold value signal, which shows a value that depends on the temperature that the temperature information shows,
wherein the discharge state determination section determines that the discharge state of the liquid in the discharge section is abnormal in a case in which the amplitude of the detection signal is less than a value, which the threshold value signal shows.

4. The liquid discharging apparatus according to claim 3,
wherein the value, which the threshold value signal shows in a case in which the temperature, which the temperature information shows, is a first temperature, which is included in a predetermined temperature range, is smaller than the value, which the threshold value signal shows in a case in which the temperature, which the temperature information shows, is a second temperature, which is included in the predetermined temperature range, and is higher than the first temperature.

5. The liquid discharging apparatus according claim 1,
wherein the viscosity of the liquid at 20° C. is 15 mPa·s or more, and 25 mPa·s or less.

6. The liquid discharging apparatus according claim 5,
wherein the viscosity of the liquid at 30° C. or more and 40° C. or less is 8 mPa·s or more, and 15 mPa·s or less.

7. A control method of a liquid discharging apparatus that includes a housing, a head unit that is provided in the housing, and includes a discharge section, which is provided with a piezoelectric element that is displaced depending on a driving signal, a pressure chamber, the internal pressure of which is increased and decreased by displacement of the piezoelectric element, and a nozzle, which is in communication with the pressure chamber, and is capable of discharging a liquid, which the inside of the pressure chamber is filled with, depending on increases and decreases in the internal pressure of the pressure chamber, a driving signal creation section that creates the driving signal, and a temperature information creation section that creates temperature information, which shows a temperature of a predetermined location inside the housing,
the method comprising:
creating a detection signal by amplifying a residual vibration signal, which shows residual vibrations that occur in the discharge section after the piezoelectric element is displaced depending on the driving signal, with an amplification factor that depends on a temperature, which the temperature information shows; and
determining a discharge state of the liquid in the discharge section on the basis of the detection signal.
